(19) United States
(12) Patent Application Publication
(10) Pub. No.: US 2008/0221848 A1
(43) Pub. Date: Sep. 11, 2008

(54) Biomolecular Structure Determination Involving Swarm Intelligence

(75) Inventors: Andrew R. Pickford, Hants (GB); Andrew Almond, Silkstone (GB)

Correspondence Address: BROOKS KUSHMAN P.C., 1000 TOWN CENTER, TWENTY-SECOND FLOOR, SOUTHFIELD, MI, 48075, US

(73) Assignee: ISIS INNOVATION LIMITED, Oxford (GB)

(21) Appl. No.: 12/064,734

(22) PCT Filed: Aug. 24, 2006
(86) PCT No.: PCT/GB06/03169

§ 371 Date: Apr. 3, 2008

(30) Foreign Application Priority Data
Aug. 24, 2005 (GB) 0517349.7

(51) Int. Cl. G06G 7/48

(52) U.S. Cl. 703/11

(57) ABSTRACT

A method and computer program for determining biomolecular structures from experimental data that includes ambiguous experimental observables comprising the steps of: creating a swarm of molecular structure generators; having the ability to allow the communication between said generators via a global set of molecular restraints; determining said molecular structure in a cooperative manner by using self-optimization of a multi-agent system. In one embodiment, NOESY spectra are used to calculate inter-proton distances of the biomolecular structure and said distances are used as molecular restraints. Moreover, the method involves restrained molecular dynamics simulations, e.g. by simulated annealing.

The present invention is concerned with biomolecular structure determination and in particular with a method for determining biomolecular structures from ambiguous experimental data using the principles of swarm intelligence.

### BACKGROUND OF THE INVENTION

A fundamental paradigm in the biological sciences is that the three-dimensional structure of proteins and nucleic acids, essentially the building blocks of life, determine their function. This paradigm emerged from the pioneering studies of Watson and Crick, who determined the structure of DNA, and Perutz and Kendrew, who solved the first structure of a protein. It soon became clear that biological macromolecules are highly structured, and that all proteins share certain three-dimensional structural features: coils (α-helices) and sheets (β-sheets), and that DNA forms an anti-parallel double helix zipped together with hydrogen bonds. These structural elements are central to their biological activity. A further breakthrough came when the first structure of a protein enzyme was resolved. The enzyme was found to have a binding pocket where the target ligand molecule fits exactly before undergoing some biochemical process, making enzymes highly specific. Today the pharmaceutical industry is interested in understanding how molecules interact with each other because it allows them to develop new drugs. Often drugs are artificial ligands that have the correct shape to fit in a binding pocket of a protein receptor, which is part of some biochemical pathway that they have established. A three-dimensional structural analysis of the receptor, while not sufficient to rationally design a ligand, can be used to propose a set of molecules that are likely to be a ligand and which may potentially be a new drug.

In a molecular experiment, each observation arises from one or more characteristics of a component of the molecule. Given sufficient experimental observations, the molecular structure may be modelled with reliability. However, when multiple components of the molecule share the same characteristic(s) the experimental observation is ambiguous, in that it can be assigned to more than one component of the molecule. Thus, the information content of the experimental observation is reduced leading to a less reliable model of the molecular structure.

The current best-practice in molecular modelling from experimental data that includes ambiguous observables is to adopt an iterative, or cyclic, scheme that aims to gradually resolve the experimental ambiguities with each cycle (FIG. 15). Initial models are generated that satisfy the unambiguous experimental observables. These preliminary models are used to evaluate the possible assignments of the remaining observables with the aim of resolving their ambiguity. The newly-resolved assignments are combined with the previously unambiguous observables in the subsequent cycle of molecular model generation and reassignment. The iterative scheme continues until all ambiguous experimental observables have been resolved and the final molecular model is produced. An iterative assignment scheme for resolving ambiguity in experimental observations is shown in FIG. 15.

Colonies of social insects can perform complex tasks (e.g. foraging, cooperative hunting and nest building) despite the simplicity of the individuals. While walking to/from a food source ants deposit pheromones on the ground which attracts other ants through a process known as “stigmergy”. In time, a pheromone trail will mark the optimal route from nest to food. Such “swarm intelligence” has been used in mathematical algorithms that can potentially solve complex combinatorial optimization problems.

Nuclei with an odd mass or odd atomic number have nuclear spin (in a similar fashion to the spin of electrons); this includes ¹H and ¹³C (but not ¹²C) and ¹⁵N. The spins of nuclei are sufficiently different that techniques, for example NMR experiments can be sensitive for only one particular isotope of one particular element by selective excitation on a multichannel NMR spectrometer. The NMR behaviour of ¹H, ¹³C and ¹⁵N nuclei are typically exploited by Biochemists, being the typical constituents of proteins, which by application of suitable pulse sequences can be used to deduce their structure.

At natural abundance proteins contain large proportions of the ¹H NMR active nuclei, but small proportions of the other nuclei of interest, ¹³C and ¹⁵N, see Table 1 below.

| Nucleus | Natural abundance (%) |
|---|---|
| ¹H | 99.985 |
| ²H | 0.015 |
| ¹²C | 98.89 |
| ¹³C | 1.11 |
| ¹⁴N | 99.63 |
| ¹⁵N | 0.37 |

Molecular biology protocols allow proteins to be produced with enhanced abundances of ¹³C and ¹⁵N. This permits heteronuclear NMR experiments to be performed, where protons can be correlated with other heteronuclei and use their chemical shift dispersion to remove overlap by application of 2D and 3D NMR experiments. From these experiments the chemical shifts of individual nuclei, even in large proteins, can be assigned.

The precise resonant frequency of the energy transition is dependent on the effective magnetic field at the nucleus. This field is affected by electron shielding which is in turn dependent on the chemical environment. As a result, information about the chemical environment of a nucleus can be derived from it resonant frequency. In general, the more the nucleus is electronegative, the higher the resonant frequency. Other factors such as ring currents (anisotropy) and bond strain affect the frequency shift. The chemical shift is defined with respect to the resonant frequency of a reference compound, for example tetramethylsilane (TMS). In this case the chemical shift of TMS would be defined to be zero. This scale is useful practically because it is independent of magnetic field strength.

δₚₚₘ=10⁶×(ν−ν_{ref})/ν_{ref} Eq. 1.1

The NMR technique is particularly useful because it permits the through-space distances between nuclei to be measured. This is possible because of dipolar spin-spin coupling between nuclei. The dipolar coupling is dependent on the distance between the nuclei (1/r⁶) and their relative orientation to the magnetic field (1-cos² θ). In solution phase NMR (as applied here) the angular component averages to zero and hence dipolar couplings are not observed directly in NMR spectra. They do, however, affect the relaxation rates of nuclei. Distance information is therefore extracted from relaxation experiments, which take advantage of phenomena such as the nuclear Overhauser enhancement.

If one nucleus is selectively irradiated then it can be shown that the NMR signals corresponding to nuclei that are located close in space are enhanced. This is called the nuclear Overhauser enhancement. The amount of enhancement is related to the distance between the nuclei and hence can be used as a method for measuring nuclei. However, this is a laborious process and is not used in protein NMR because individual nuclei cannot be excited separately. Instead, the NOESY (NOE SpectroscopY) experiment is typically applied. In its most basic incarnation it is a 2D experiment that correlates all protons. During a user definable relaxation period (the mixing time) magnetisation is transferred between nuclei that are closely separated in space. Therefore, signal is seen to move from the diagonal to cross-peaks that are found at the chemical shifts of the two nuclei involved. Due to the nuclear Overhauser effect the cross-relaxation rate for this transfer is related to the distance (1/r⁶). The intensity of cross peaks are related to the distance between nuclei. Low signal equates to large distance, large signals to close distances. If the two nuclei have been identified in the protein structure and assigned to particular chemical shifts then this distance can be used as a conformational restraint in the NMR structure determination problem. The cross-peaks are commonly referred to as “NOEs”. Typically, the assignment of proton chemical shifts uses heteronuclei (¹⁵N and ¹³C) and NOESY spectra are obtained from 2D proton spectra, or a 3D experiment with an extra ¹⁵N dimension.

When spin pairs are isolated (and the protein of interest is tumbling isotropically) the cross-relaxation rate can be shown to be exactly proportional to 1/r⁶. Here, the intensities for a particular mixing time are easy to calculate. However, this is not true in a protein, where the density of protons can be high. In general this problem has to be solved by taking into account all possible proton pathways—the so called full relaxation matrix approach. Each possible interaction is represented by a cross-relaxation rate in a 2D matrix, and the intensities are computed using linear algebra approaches. This is computationally intensive and complicated. However, even in a protein, if the mixing time is kept short, then the NOESY cross-peak intensity is approximately proportional to 1/r6. This is the independent spin-pair approximation. The largest useful mixing time can be estimated by performing test experiments with varying mixing times, and establishing the point at which the NOESY cross-peak intensities become non-linear with mixing time. This regime is most frequently used in NMR structure determination of proteins because of its computational simplicity and linearity.

The donor and acceptor protons in an NOE are identified from the chemical shifts of the NOESY crosspeak. When each chemical shift relates to only a single proton resonance, the donor and acceptor protons can be assigned unambiguously. However, when either of the chemical shifts can be attributed to two or more proton resonances, the NOE is said to be ambiguous. In order to resolve this ambiguity, we need to know the three-dimensional structure, but in order to determine the three-dimensional structure we need to assign all the NOEs. This dilemma is known as the NOE assignment problem and is illustrated in FIG. 16.

To date, the most successful strategies for resolving the NOE assignment problem have used iterative assignment schemes analogous to that in FIG. 17. This is the strategy adopted by the most commonly used computer programs for biomolecular structure determination today, ARIA/X-PLOR/CNS, DYANA/CYANA and AUTOSTRUCTURE. In each case, those crosspeaks in the NOESY spectrum that are distinguishable from noise are “picked” in preparation for NOE assignment and interproton distance calibration. Thereafter, there follows multiple cycles of NOE assignment and calibration, biomolecular structure determination and structure selection. In the first round, the unambiguous NOEs are calibrated into distance restraints in order to calculate a preliminary set of structures, a fraction of which are selected for NOE reassignment. Because only a subset of the possible experimental observations is used, these initial conformers have a very low level of precision. However, they may be of sufficient accuracy to discriminate between the assignment possibilities of a subset of the ambiguous NOEs. Therefore, the list of assigned NOEs is expanded and the fraction of unused experimental observations decreases. Eventually, after multiple cycles of re-assignment, re-calibration and re-calculation the procedure yields a solution structure that is compatible with the crosspeaks picked from the NOESY data.

The multi-step iterative assignment procedure has flaws at every stage. For instance, the peak-picking can be highly erroneous and subjective, particularly in the case of identifying the chemical shifts, and measuring the intensities/volumes of overlapping NOESY crosspeaks. Another disadvantage is that mistakes made in the assignment of the initial set of unambiguous NOEs are propagated through every subsequent cycle, leading to consequent mis-assignments and mis-calibrations and resulting in an erroneous solution structure.

An iterative assignment also performs a restraint calibration on a limited subset of NOEs rather than the whole spectrum leading to further subjectivity. Furthermore, the poor definition of the initial set of biomolecular structures requires that many conformers must be calculated for a statistically meaningful analysis of the ambiguous NOEs and the selection of structures is prone to subjectivity and bias. In addition, the iterative assignment is time consuming, and is highly wasteful in that the number of structure calculations performed far exceeds the number of conformers required to define the solution structure.

### SUMMARY OF THE INVENTION

The present invention seeks to alleviate the problems associated with the prior art by utilizing the principle of swarm intelligence to achieve a single-step determination of biomolecular structures from ambiguous experimental observables.

This is achieved through the creation of a swarm of molecular structure generators, which are able to communicate via a global set of molecular restraints derived from the experimental observables to determine the molecular structure in a cooperative manner.

Therefore, according to first aspect of the present invention, there is provided a method of determining bio-molecular structures from experimental data that includes ambiguous experimental observables comprising the steps of: creating a swarm of molecular structure generators; having the ability to allow the communication between said generators via a global set of molecular restraints; determining said molecular structure in a cooperative manner by using self-optimization of a multi-agent system.

According to a second aspect of the present invention, there is provided an apparatus adapted to determining biomolecular structures from experimental data that includes ambiguous experimental observables comprising

(i) generating means for creating a swarm of molecular structure generators having the ability to allow the communication between said generators via a global set of molecular restraints; and

(ii) determining means for determining said molecular structure in a cooperative manner by using self-optimization of a multi-agent system.

According to a third aspect of the present invention, there is provided a computer program adapted to be run on a computer, for determining biomolecular structures from experimental data that includes ambiguous experimental observables, comprising the steps of the method mentioned above.

Thus, advantageously, in utilizing the principles of swarm intelligence, the biomolecules are able to communicate via a global restraint list. Any single conformer which encounters a favourable sub-structure, for example, a native-like α-helical turn or β-hairpin in proteins, encourages the other members of the swarm to adopt this conformation by updating the molecular restraints. Therefore, the molecules cooperate in finding the optimal restraints and thus determine their own molecular structure.

Preferably, the bio-molecular structures are determined by using Nuclear Magnetic Resonance (NMR). However, other techniques may be utilized, such as for example, x-ray crystallography, neutron scattering, and the like and which would be known to the person skilled in the art.

Preferably, the experimental observables are Nuclear Overhauser Effects (NOEs) for automated single-step bio-molecular structure determination.

The present invention offer particular advantages over previously used techniques, such as iterative assignment. Firstly, there is no peak picking of the NOESY spectra which is highly speculative and, therefore, no problems associated with overlapped and/or aliased crosspeaks. Furthermore, there is no calibration of interproton distance restraints. Instead, those distances that give rise to “good” spectral solutions are remembered. Interproton distance restraints are transient and modified on-the-fly during the course of the swarm evolution, so assignment errors are neither propagated nor amplified. The technique is also objective: all possible donor-acceptor NOE pars are considered from the outset and there is no selection of conformers.

In FIG. 16, a swarm intelligence scheme is illustrated for resolving ambiguity in experimental observations. The swarm of molecular structure generators are able to communicate via a global set of molecular restraints derived from the observables and determine the molecular structure in a cooperative manner.

The present invention will now be described in more detail with reference to the exemplary embodiments which are provided by way of example only.

### BRIEF DESCRIPTION OF THE DRAWINGS

FIG. 1 is an illustration of an overview of the architecture of NMRswarm.

FIG. 2 is a preparation of the Topology and Swarm.

FIG. 3 is a preparation of the NMR Data.

FIG. 4 shows On-the-Fly NOESY Backcalculation in NMRswarm.

FIG. 5 shows un update of the NOE Restraints in NMRSwarm.

FIG. 6 is a graphical user interface of NMRSwarm.

FIG. 7 is a geometry user interface of NMRswarm.

FIG. 8 shows the library GUI of NMRSwarm.

FIG. 9 shows how a segment is built in the Topology GUI of NMRSwarm.

FIG. 10 is a segment viewer in the Topology GUI of NMRSwarm.

FIG. 11 displays the NOE Viewer/Editor in the Topology GUI of NMRSwarm.

FIG. 12 displays a Swarm GUI of NMRSwarm.

FIG. 13 shows the NMR conditions GUI of NMRSwarm.

FIG. 14 depicts the NMR Spectrum GUI of NMRSwarm.

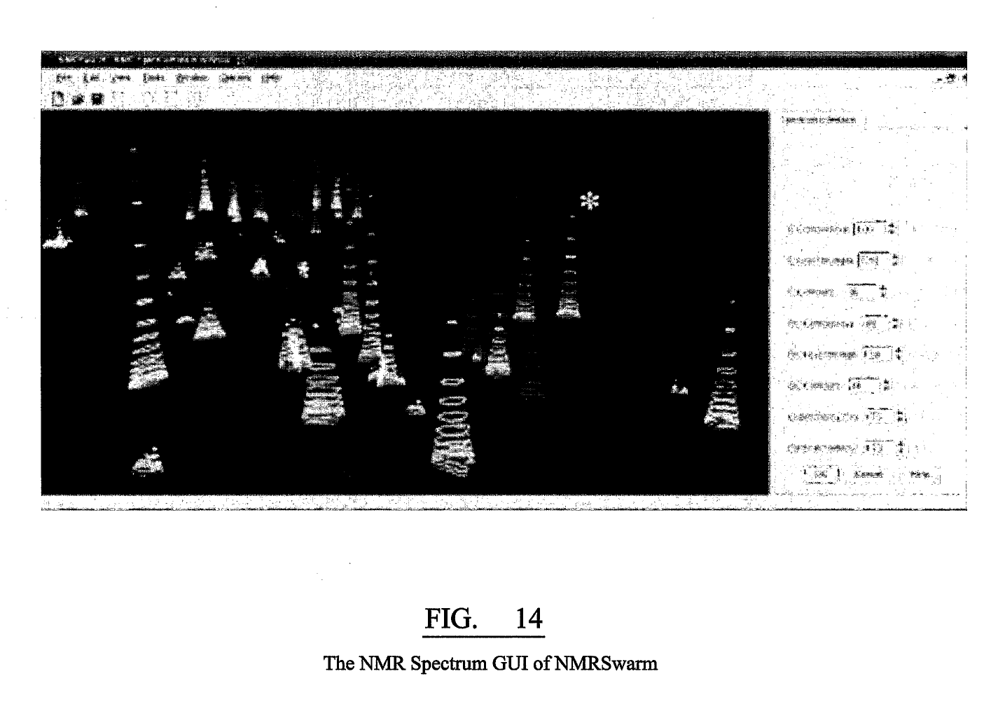

FIG. 15 is an iterative assignment scheme for resolving ambiguity in experimental observations.

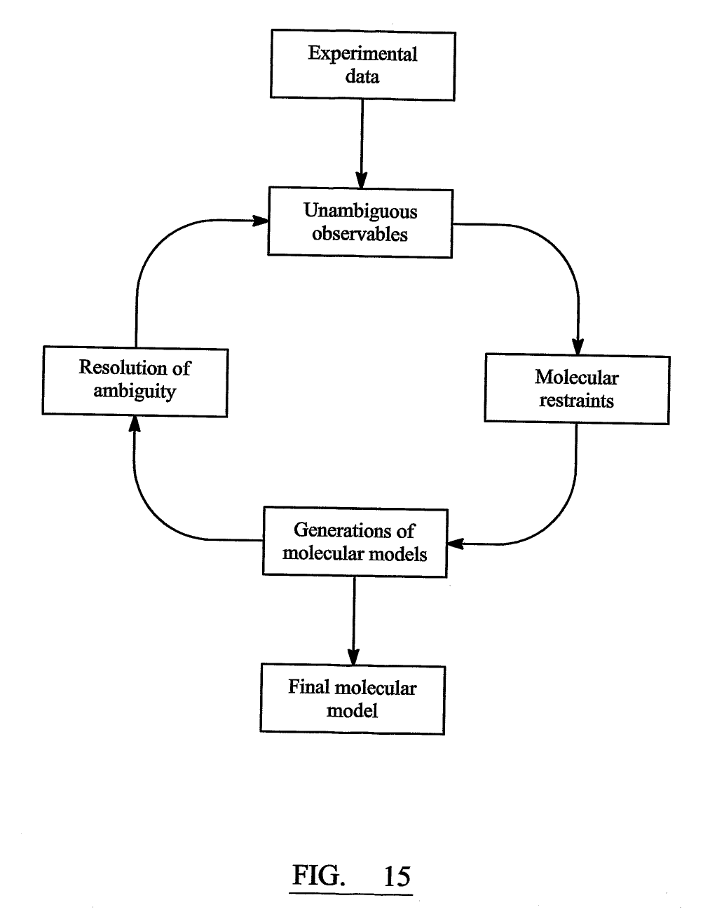

FIG. 16 is a swarm intelligence scheme for resolving ambiguity in experimental observations.

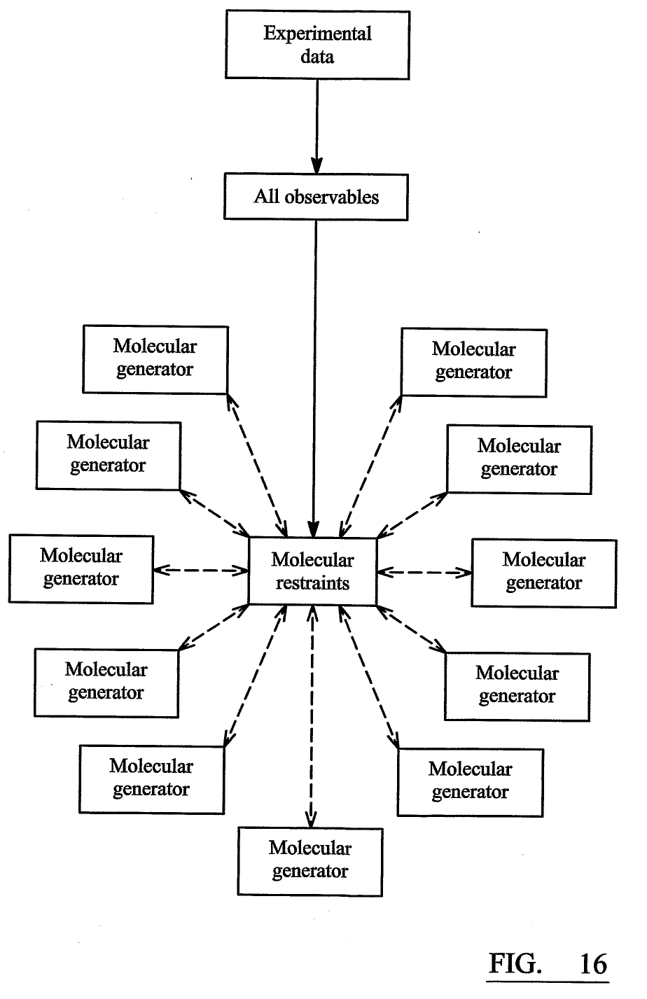

FIG. 17 is a graphic illustration of an iterative assignment scheme for resolution of ambiguous NOEs.

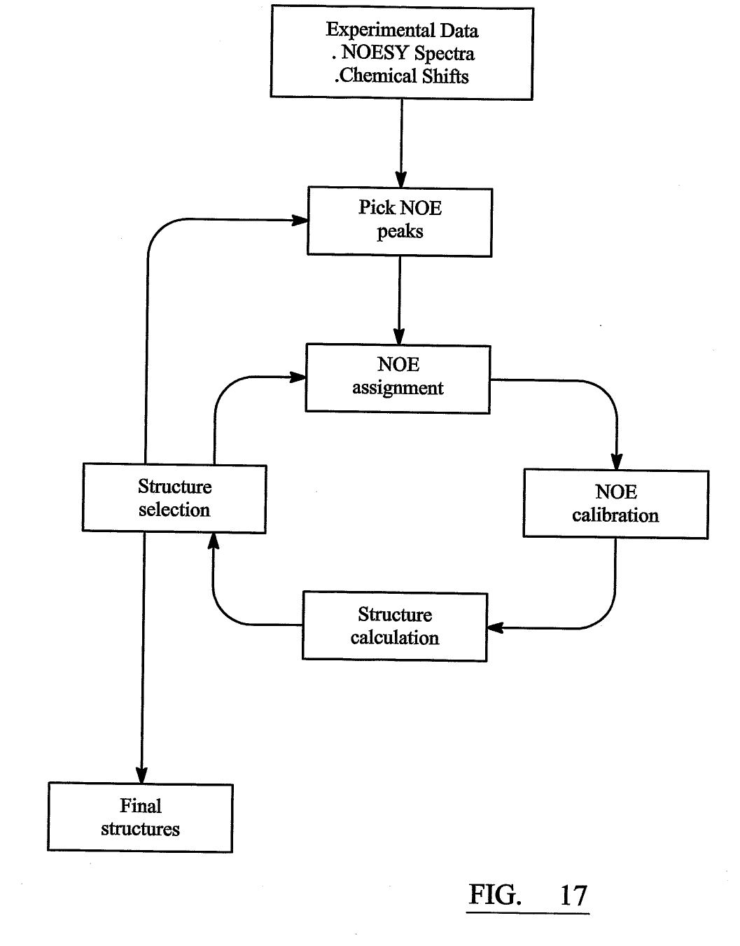

FIG. 18 is a schematic representation of a swarm intelligence-based NMR structure determination

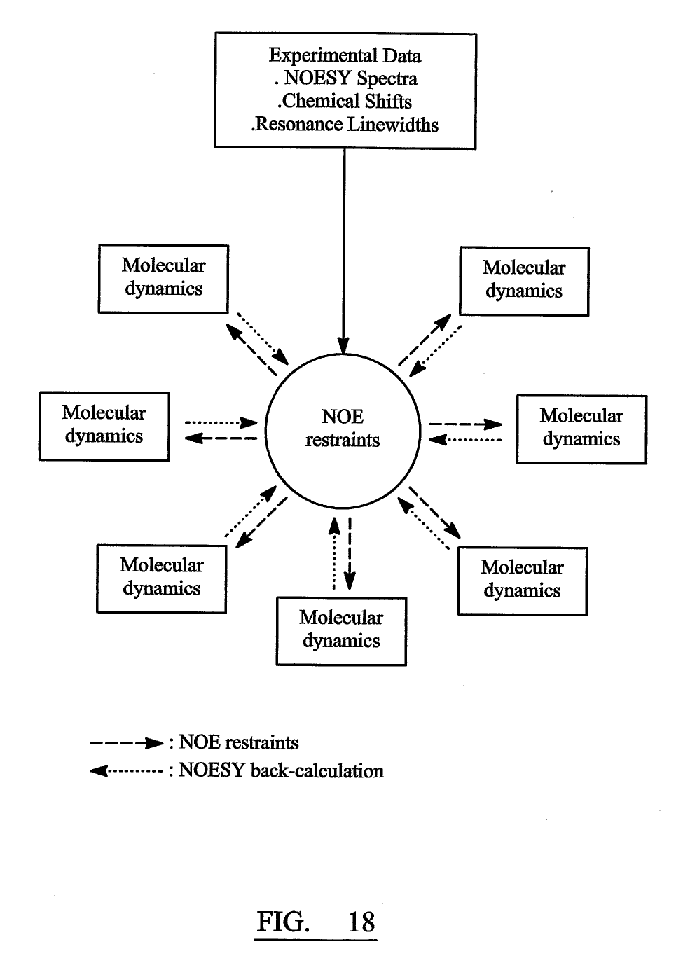

FIG. 19 is a graphic representation of a pseudo-harmonic E_{NOE} potential.

FIG. 20 is a graphical representation of the half-sigmoidal temperature and Van der Waals force constant ramps applied during the simulated annealing.

FIG. 21 illustrates the evolution of the ¹F2 module swarm.

FIG. 22 illustrates a correlation between back-calculated and experimental NOESY data.

FIG. 23 illustrates a comparison of the Swarm Intelligence NMR structure of ¹F2 with that derived previously by the iterative-assignment of NOEs.

FIG. 24 illustrates the evolution of the FERM3 swarm.

FIG. 25 illustrates a comparison of the Swarm Intelligence NMR structure of FERM3 with the one derived from X-ray crystallography.

The present application describes a method of determining bio-molecular structures from experimental data that include ambiguous experimental observables, such as for solving ambiguous NOE data, by applying the principles of swarm intelligence. It will be shown that this procedure alleviates the disadvantages associated with prior art methods such as iterative assignment.

As aforementioned, this method is not limited to solving ambiguous NOE data and it may also be used for a range of physical techniques that can be used to model proteins. In fact, any property that is related to physical size and shape or from which a structural constraint can be inferred. Examples of physical techniques where the method of the present application can be implemented are:

X-ray crystallography

Neutron scattering

Solution state X-ray scattering

Solution state laser scattering

Size exclusion chromatography

Analytical ultracentrifugation

NMR relaxation and exchange measurement

NMR chemical shift perturbation

Kinetics data from surface plasmon resonance

Solid-state NMR

Atomic force microscopy

Fluorescence energy transfer

Analytical ultracentrifugation

Mass spectrometry

Circular dichroism

Homology modelling data (& other similar bioinformatics techniques)

Epitope mapping using antibodies

Calorimetry

An Overview of the NMRSwarm Program

The Modules of NMRSwarm

The architecture of NMRSwarm can be split into four approximately autonomous modules: Geometry, Library, Topology, Swarm and NMR. These provide the C++ classes for the program, the building blocks upon which the architecture is constructed. Two additional modules, Utility and Molecule perform supplementary roles. The Utility module provides numerous base classes that are inherited by many other classes in the other Modules. The Molecule module provides a family of classes that are the bases for the construction of the Library, Topology and Swarm objects.

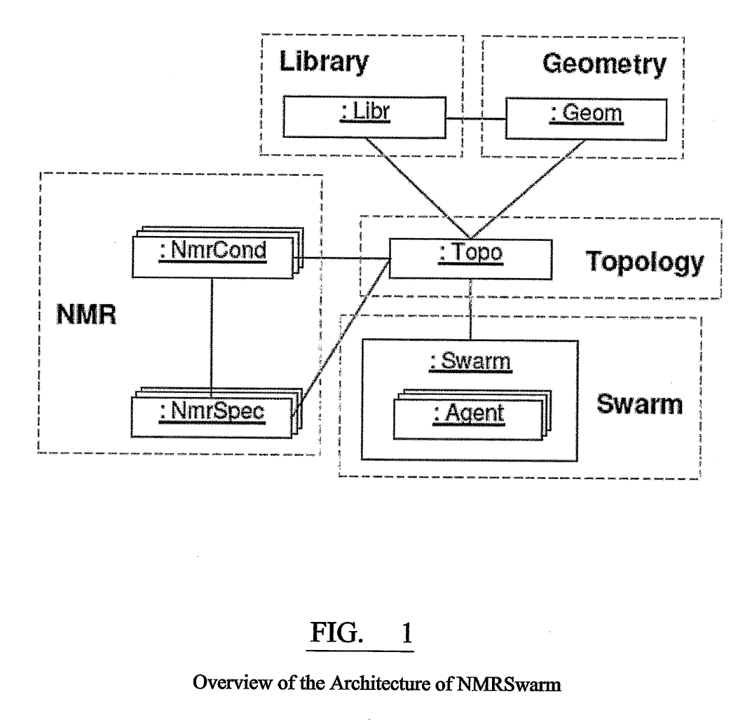

The key interactions between objects in the NMRSwarm program are depicted in FIG. 1. The Swarm itself consists of an array of molecular Agents, each of which is cloned from a Topology template (:Topo) which is turn is constructed from a Library (:Libr) of residues and linkers and a database of geometric parameters (:Geom). The Topology also provides atomic information to the NMR module for the construction of resonances and spectral crosspeaks which are accessed by the Swarm during backcalculation of NMR spectra.

Preparing the Topology and Swarm

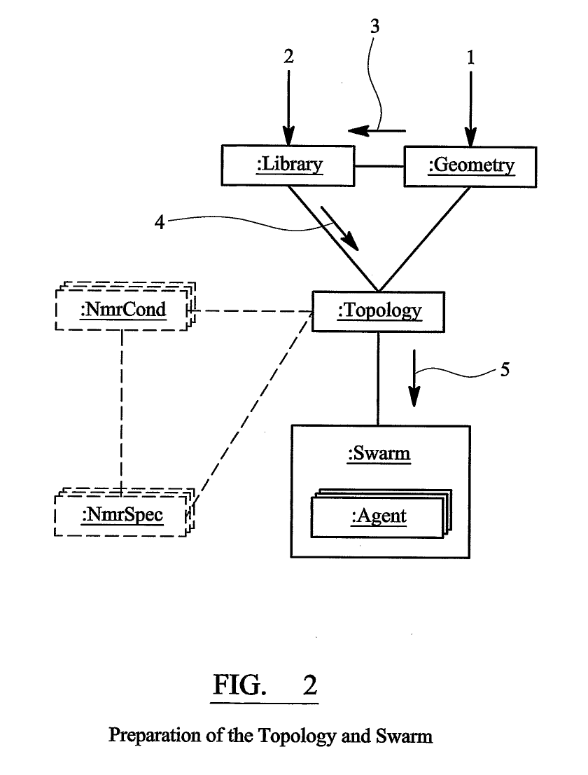

The first stage in the swarm intelligence structure calculation process in NMRSwarm is the preparation of one or more segments in the molecular topology (FIG. 2). This is performed by “polymerization” of Library residues (:LibrResi) using Library links (:LibrLink) according to a user-defined sequence. The Library residues and patches must first be generated from templates input from file or the graphical user interface (GUI), and suitable Geometry data.

The completed Topology has all the information required to clone Agents and to produce NMR resonance lists for each set of the NMR conditions. It also contains a master NOE array for management of the NOE restraints during the swarm intelligence structure calculation process.

Preparing the NMR Data

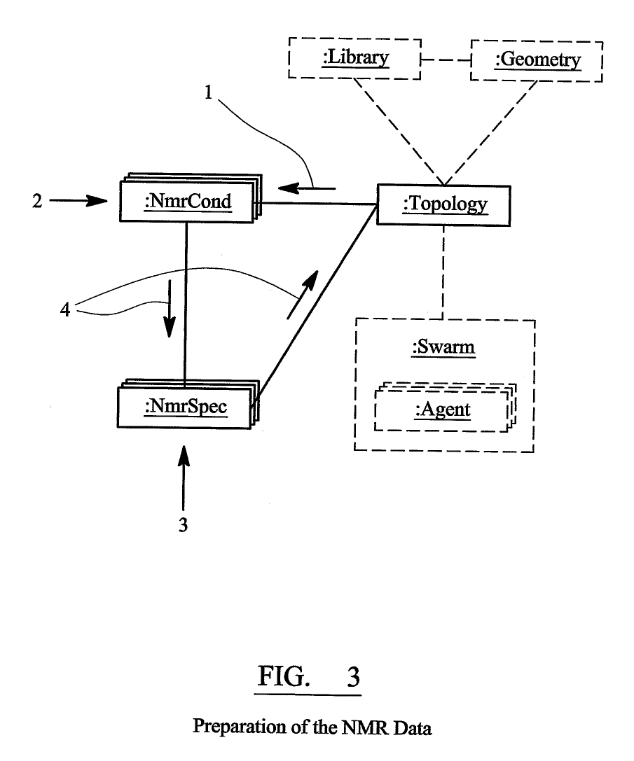

An NMR conditions object (:NmrCond) is constructed for each set of conditions (field strength, pH, ionic strength, etc.) under which NMR spectra were recorded on the specified Topology. Upon construction, the NmrCond object shown in FIG. 3 automatically generates a complete (but unassigned) list of NMR resonances (:NmrReso) for the Topology which may be edited by the user via the GUI or modified by loading of previously stored resonance information from file.

Multiple NOESY NMR spectra (:NmrSpec) can then be loaded into each set of NMR conditions. Upon loading of the spectrum, NMRSwarm automatically generates all possible NOE crosspeaks (:NmrXpk) and links these to the NOE array in the Topology. Subsequent alterations to the NMR resonances result in spontaneous changes in the magnitude, shape and/or positions of the NOE crosspeaks in the spectra. Regions of the NMR spectra which contain artefacts may be omitted from analysis through the application of masks (:NmrMask).

Swarm Intelligence Structure Calculation in NMRSwarm

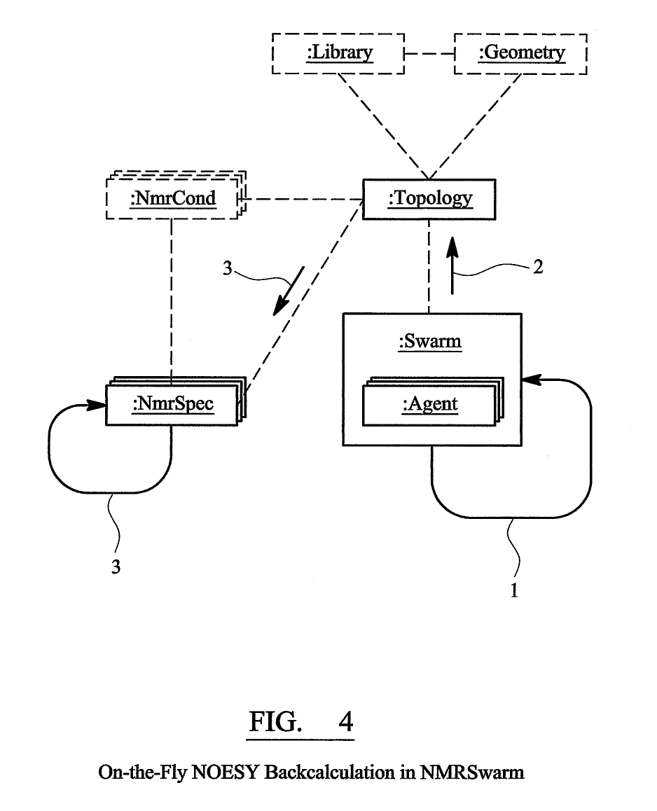

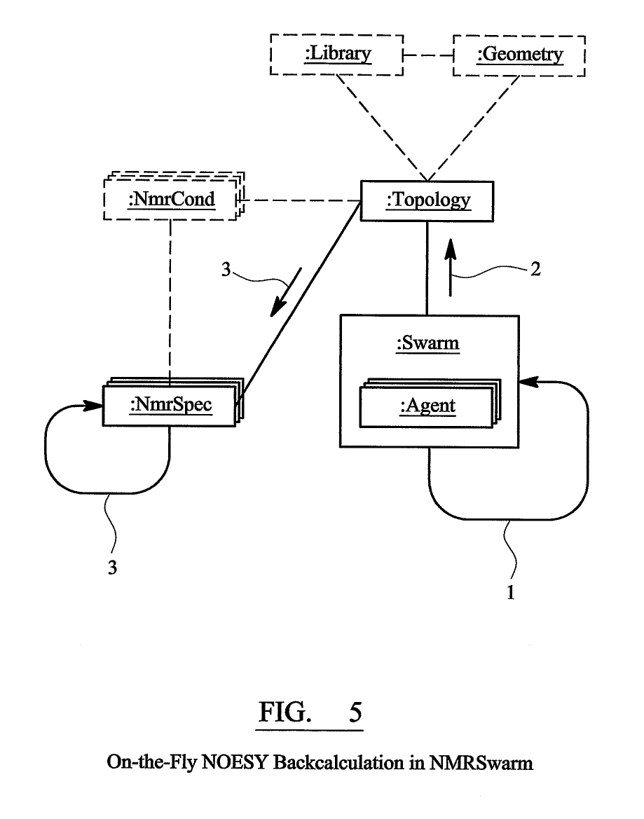

The swarm intelligence structure calculation method in NMRSwarm is summarized in FIGS. 4 and 5. In brief, the Swarm of molecular Agents are undergoing restrained molecular dynamics simulations starting from randomized conformations but all governed by a global NOE restraint list (in the: Topo). Periodically, the current inter-proton resonance distances at any point in time for one randomly-chosen Agent are copied into a “test slot” of the NOE array. From here they are used to back-calculate hypothetical NOESY spectra that would be produced if the current conformation was the correct one.

These back-calculated NOESY spectra are normalized against the experimental NOESY intensities by calculating the correlation coefficients over those unmasked, non-diagonal spectral intensities.

The goodness-of-fit between the back-calculated and experimental NOESY crosspeaks is evaluated from a χ² test of the intensities. Those test interproton resonance distances that resulted in an improvement in the χ² of the crosspeaks are recorded and used to update the NOE restraints in the global NOE list. The new NOE distance restraints are passed back to all Agents in the Swarm via the Topology, and the restrained molecular dynamics simulations continue. In this way, the NOE distances in those regions of the conformation of the tested Agent that agree well with the experimental data are communicated to all other Agents in the Swarm. The backcalculation-and-update cycle is then repeated for each of the other Agents.

Once all Agents have been tested, the memorized χ² values for the NOESY crosspeaks are increased by a constant factor (typically 1-5%). This so called “pheromone decay” makes an NOE distance update more likely for the subsequent cycles, allowing for mistakes in the NOE assignment procedure to be corrected by the Swarm.

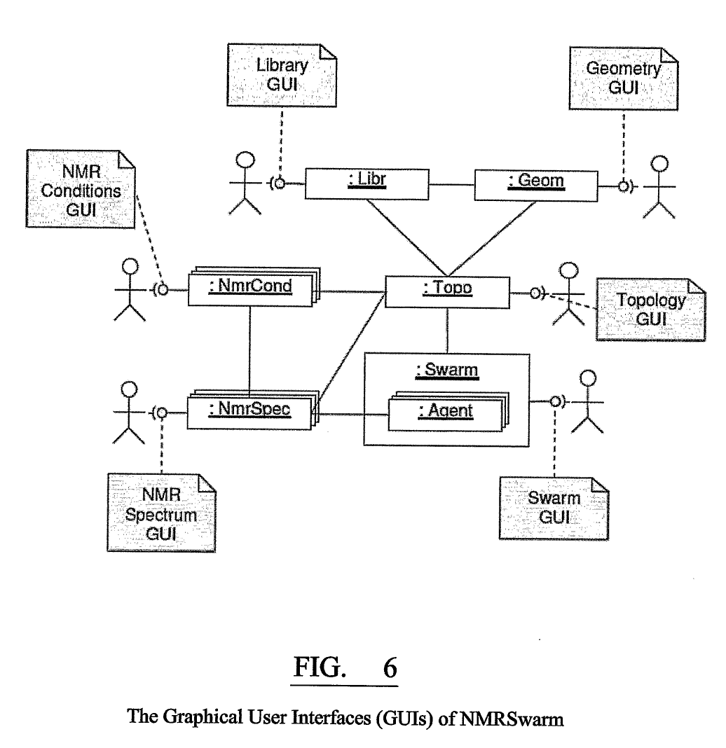

In FIG. 6, a biomolecular swarm is defined as a colony of molecular agents that are searching their conformational (interproton distance) space through molecular generators, which, in this case, are parallel restrained molecular dynamics simulations. Each of these agents back-calculates simulated NOESY data from its current conformation, and, depending on its degree of agreement with the experimental NOESY data, updates a global interproton distance list that is then applied as restraints in the molecular generators. Thus, the agents communicate by stigmergy, mutually updating and reacting to the restraint list.

In such a swarm, if any of the molecular agents encounters a conformation that agrees well with the experimental data (for example, a native-like β-hairpin or an α-helical turn in proteins), this knowledge is communicated instantly to the other molecule agents in the swarm. Therefore, over time the NOE restraint list will evolve to the correct set of interproton distances that describes the conformation of the molecule. The swarm of molecular agents is then attracted by this set of restraints towards the correct three-dimensional structure.

Graphical User Interface

The graphical user interface (GUI) of NMRSwarm allows the user to observe and interact with all aspects of the swarm intelligence structure calculation process. FIG. 6 shows the GUI comprising six separate interfaces allowing complete observation of, interaction with and intervention in the entire NMRSwarm system, i.e. the Geometry, Library, Topology, NMR Conditions, NMR Spectrum and Swarm modules.

Geometry Interface

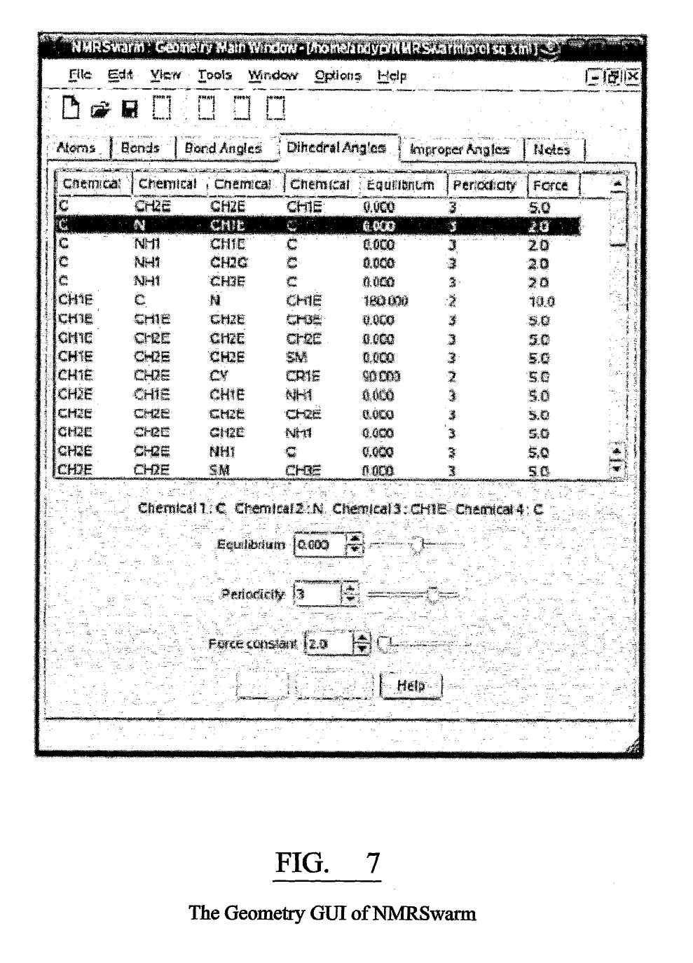

The Geometry multiple document interface of NMRSwarm allows the user to create, edit, load, save and delete Geometry files. Each document has multiple window tabs which provide access to the Geometry atoms, bonds, angles, dihedrals and impropers, which is shown in FIG. 7. Clicking on any of the Geometry Atoms updates the Atom attributes editor sliders at the bottom of the table allowing the user to modify these values. Clicking on any of the Geometry constraints updates the equilibrium distance and force constant (and periodicity in the case of dihedrals) editor sliders at the bottom of the table and allows the user to manually edit these values for the selected constraint.

Library Interface

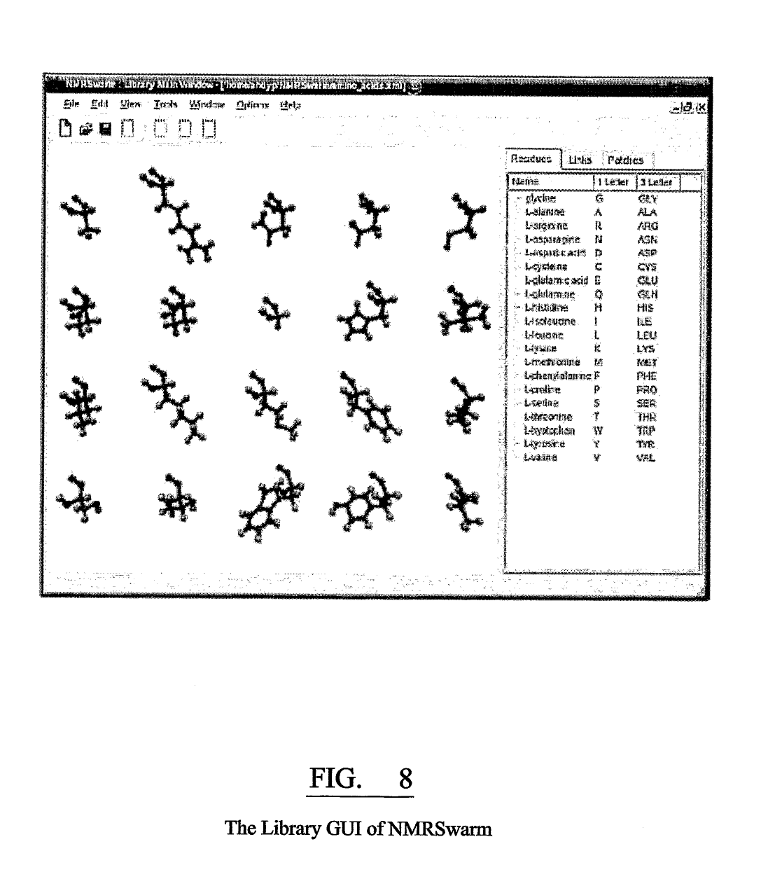

The Library multiple document interface of NMRSwarm shown in FIG. 8 allows the user to load, save and delete Library files. Each document has an OpenGL-based molecular viewer, which presents the Library Residues in any of a number of viewing modes (lines, ball-and-stick, space-fill or tubes) and multiple window tabs, which provide access to information on the Library Residues, Patches and Links.

Topology Interface

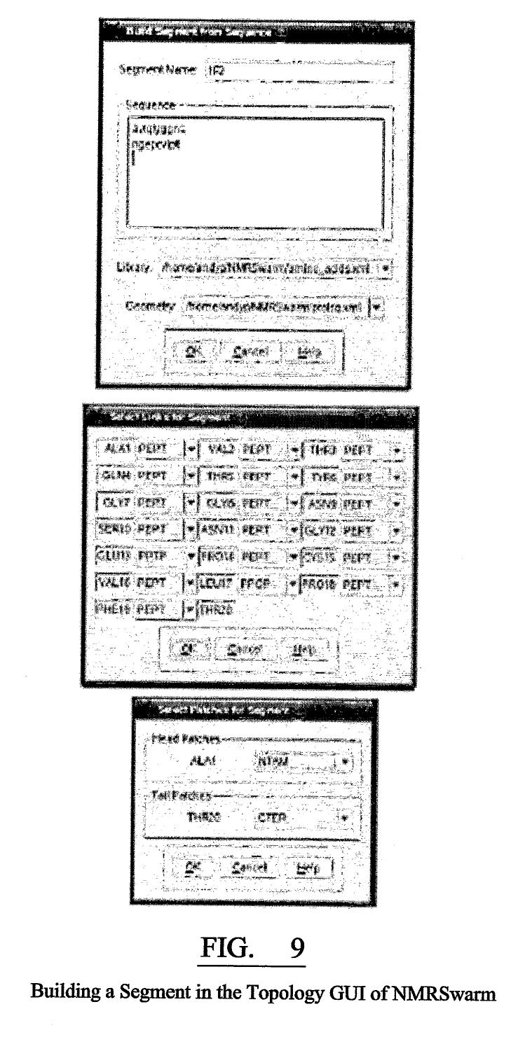

The Topology multiple document interface of NMRSwarm allows the user to create, edit, load, save and delete Topology files. The topologies are written to files in an XML (extensible markup language) format. Topology segments are built from sequences of library residues using a single-letter code and the appropriate Library and Geometry document files (FIG. 9). Each segment is given a four-letter name similar to the accession code of a Protein Data Bank (PDB) entry.

Inter-residue Library links are selected for each pair of residues, for example a transpeptide bond (PEPT) or a cisproline peptide cond (PPCP) in a polypeptide chain. Finally, the first and last residues may be modified using a Library patch, e.g. with primary amine (NTAM) and carboxylate (CTER) groups for the N— and Ctermini of a polypeptide.

The resultant topology segment may be examined using the OpenGLbased molecular viewer of NMRSwarm which presents the topology in any of a number of viewing modes (lines, ball-and-stick, spacefill or tubes). The Topology GUI also presents a list view tree of the segment structure together with tabulated lists of its geometric constraints.

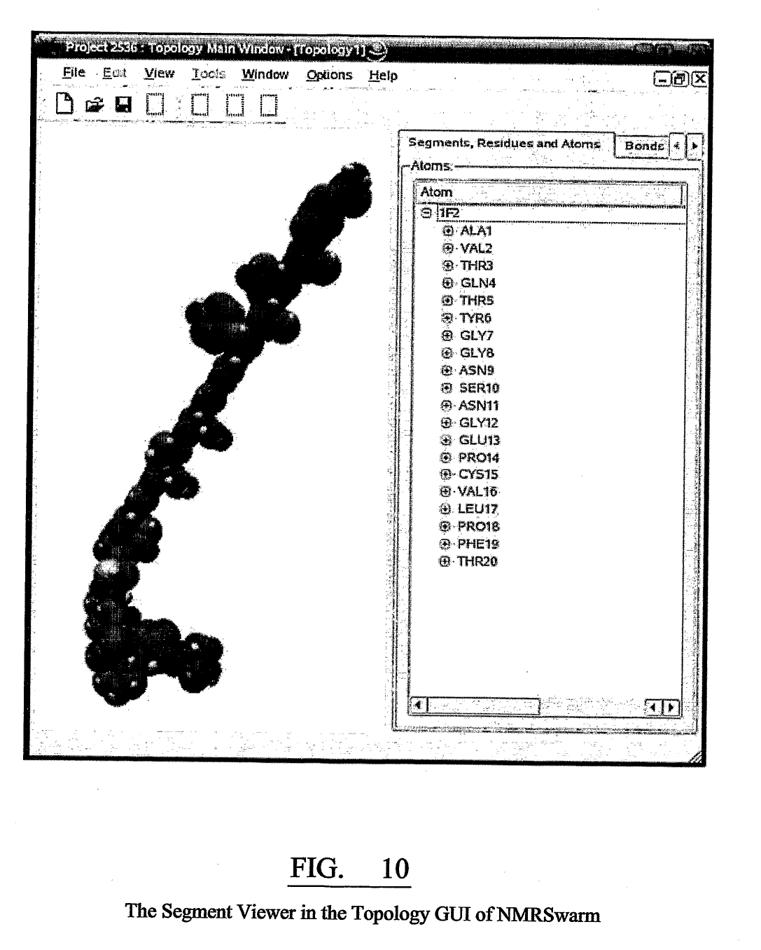

In FIG. 10, the icosapeptide segment AVTQTYGGNSNGEPCVLPFT is shown in the segment viewer in the Topology GUI of NMRSwarm. Amongst the tabulated data in the Topology GUI is a cascading interproton NOE viewer/editor.

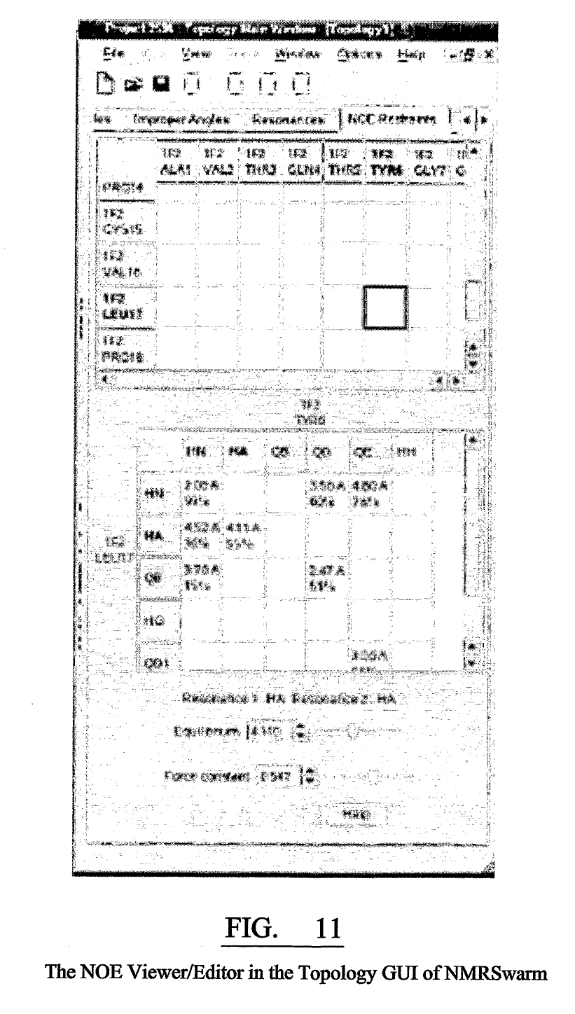

All possible inter- and intraresidue interactions in the topology are shown at the top of the NOE table in FIG. 11. When the user clicks on a residue-residue pairing, the lower portion of the table is updated to display all possible inter-proton NOEs for the selected residue pair. Those NOEs, which are switched on, have their equilibrium distance (in Å) and force constant (in %) shown.

Clicking on any of the interproton NOE boxes updates the equilibrium distance and force constant editor sliders at the bottom of the table and allows the user to manually edit these values for the selected NOE.

When the program is performing the swarm intelligence structure calculation, the contents of the NOE table are updates in real time to allow for monitoring of the progress of the NOE assignment process.

Swarm Interface

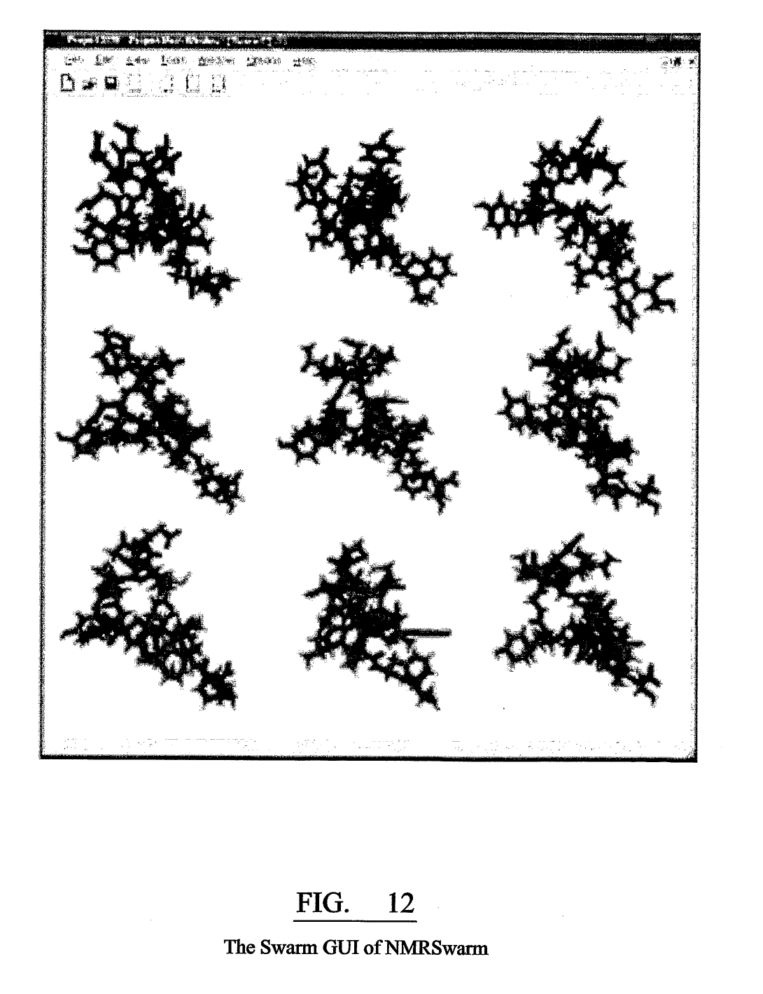

The Swarm multi-document GUI of NMRSwarm features an OpenGL viewer, which shows a real-time display of the molecular dynamics simulations and allows for independent rotation, translation and selection of the molecular agents. Pull-down menus allow the user to start and stop the molecular dynamics and NOESY back-calculation loops (i.e. the swarm intelligence calculations), and to load or save coordinate files in a PDB format. FIG. 12 shows a nine-agent swarm of the icosapeptide AVTQTYGGNSNGEPCVLPFT in the “tube” viewing style. The agents have undergone 25 ps of swarm intelligence based structure determination coupled to a two-dimensional 1H-1H NOESY spectrum.

NMR Conditions Interface

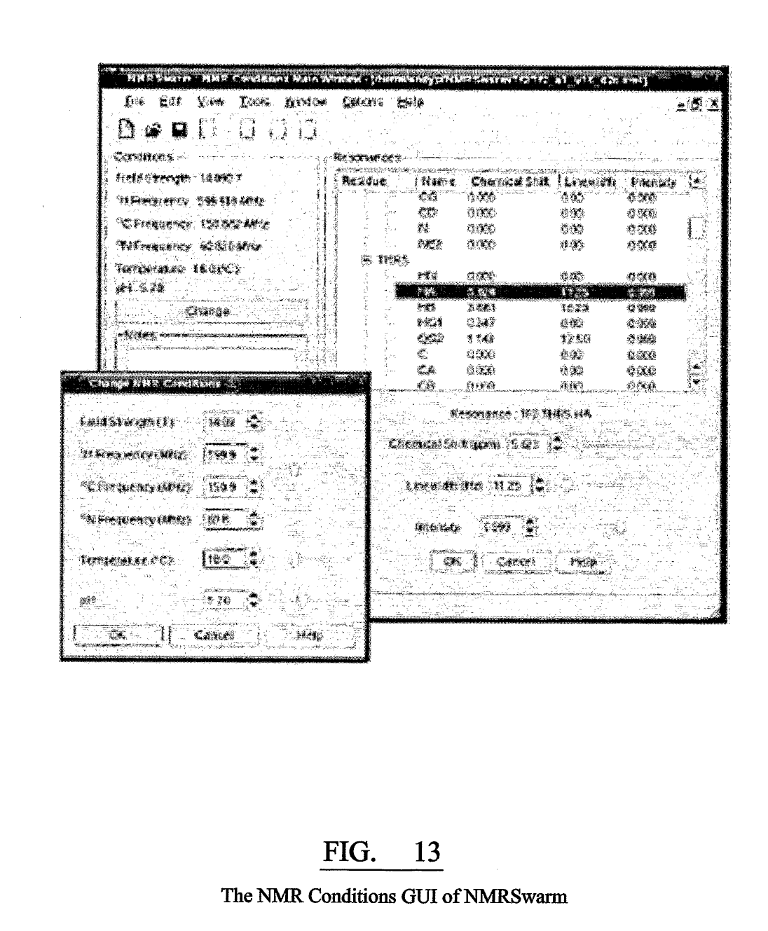

The NMR Conditions multi-document GUI of NMRSwarm shown in FIG. 13 allows the user to create, edit, load, save and delete NMR conditions. Conditions are loaded from file or generated ab initio using a pre-existing Topology. A pop-up menu allows the user to edit the field strength, pH and temperature of the conditions, whilst an interactive list view tree provides a convenient means of modifying the chemical shifts, linewidths and intensities of selected resonances.

NMR Spectrum Interface

The NMR Spectrum multi-document GUI of NMRSwarm allows the user to load NMR spectra, couple them to a topology and view the progress of the swarm calculation in real time from the level of agreement between the experimental and back-calculated or restraint intensities.

Owing to the difficulty of comparing peak intensities in traditional orthographic contour plots of NMR spectra (which is usually done by “contourcounting”), NMRSwarm offers a three-dimensional perspective view of the spectra in addition to the orthographic projection. The user may zoom, rotate and pan through the spectrum and adjust the contour level, the contour level multiplier and the number of contours. This allows to user to easily identify correctly assigned NOEs as well as those that are over- or under-constrained. In addition, errors in resonance chemical shift and/or linewidth may be seen.

A region of a 2D NOESY spectrum is shown is perspective mode with experimental NOE crosspeaks shown in green and NOE restraint crosspeaks in red. Where crosspeaks appear yellow, such as that marked with an asterisk (*), there is an excellent agreement between the experimental data and NOE restraint distance.

Software Implementation

Molecular Topology Class

Generated from CNS

A molecular topology, which defines the covalent structure of the molecule, was generated for each protein using the program CNS version 1.0 (Brünger et al., 1998) and the residue templates described in the file “topallhdg.pro”. The molecular topology is written to an ASCII file in a STAR format.

Treatment of Disulphide Bonds

For those proteins containing disulphide bonds, the cysteine residues were oxidised (by removing the γ-sulphydryl protons) but no bond or bond angle constraints were applied between the sulphur atoms.

Input into the NMRSwarm Program

The STAR format molecular topology files generated by CNS are read directly into the NMRSwarm program.

Molecular Agent

Description

Each molecular agent object contains coordinates, velocities and accelerations for each atom in the molecule (as described by the molecular topology), together with kinetic and potential energy variables.

Initial Coordinates

Initial randomized coordinates for swarm intelligence structure calculations were produced using the program CNS version 1.0 (Brünger et al., 1998) using the protein's molecular topology file. In brief, coordinates of the atoms were randomized and then the covalent structure and local geometry were regularized using the bond length, bond angle and torsional parameters specified in the all-atom forcefield PROLSQ (Linge & Nilges, 1999) but without the application of constraints defining disulphide bonds. Finally, the backbone torsional angles (θ and ψ) were randomized for every residue excluding proline. The multiple initial sets of molecular coordinates were concatenated into an ensemble coordinate file (in Brookhaven PDB format) with each conformer segregated by the MODEL and ENDMDL keywords.

Coordinate Input and Output in NMRSwarm

Molecular coordinates are read into and written from NMRSwarm in the Brookhaven PDB ensemble coordinate format.

Molecular Resonance

Each molecular resonance object comprises a chemical shift (δ), linewidth (λ) and occupancy (ρ) for a given nucleus (or group of magnetically-identical nuclei) in the molecule for a given set of conditions (temperature, pH, ionic strength, field strength, etc.).

Measurement of Chemical Shift and Linewidth

Where possible, the chemical shift and linewidth of each molecular resonance is measured from well-separated, high-intensity crosspeaks in the NOESY spectra. In cases of severe spectral overlap, the chemical shifts and/or linewidths are estimated from analysis of chemically-equivalent resonances in better resolved regions of the spectra. In each case, chemical shifts are documented in parts per million (ppm) to 3 decimal places, and linewidths to the nearest Hz.

Fractional Occupancy

The fractional occupancy (ρ) of a given resonance in a sample is the proportion of atoms that contain an NMR-active nucleus. For example, a protein sample at chemical equilibrium in 5% D₂O/95% H₂O will have solvent-accessible backbone amide groups that are only 95% protonated and thus have a fractional occupancy of 0.95. In the same sample, all non-exchangeable proton resonances will have a fractional occupancy of 1.0.

Gaussian Resonance Lineshapes

A Gaussian resonance is described by the continuous probability density function:

$$f ( x ) = \frac{ρ}{σ \sqrt{2 π}} {e}^{- {( x - δ )}^{2} / 2 {σ}^{2}} \qquad Eq . 2.1$$

where ρ is the fractional occupancy of the resonance, δ is its chemical shift (in ppm), and σ, the standard deviation of the Gaussian distribution, is given by:

$$σ = \frac{λ}{2 ω \sqrt{2 ln 2}} \qquad Eq . 2.2$$

where λ is the linewidth (in Hz) at half-maximal height and ω is the carrier frequency (in MHz). For each spectral dimension with digital resolution ζ (Hz/point), each observable resonance is digitized into evenly-distributed discreet points:

$$g ( {x}_{i} ) = \frac{ρ}{σ \sqrt{2 π}} {e}^{- {( {x}_{i} - δ )}^{2} / 2 {σ}^{2}} \qquad Eq . 2.3$$

where the positive integer

$$i \leq \frac{2 κσ}{ζ} .$$

The constant κ determines the degree of coverage of the Gaussian resonance; a value of 3.0 encompasses 99.7% of the total intensity.

Molecular Resonance Input and Output in NMRSwarm

Molecular resonances are read into and written from NMRSwarm in a STAR file format.

NOESY Data

NOESY spectral data are imported into NMRSwarm in either FELIX or NMRView format. The spectrometer frequency (ω), spectral width (sw), reference shift and reference point of each spectral dimension are retrieved from the header of the NOESY file. The field strength (Φ) is supplied by the user. The observable gyromagnetic ratio (γ) for each dimension is determined according to the equation:

$$γ = \frac{2 πω}{Φ} \qquad Eq . 3.1$$

The spectral intensities are read into memory in a serial format, decomposing the sub-matrix format in the FELIX and NMRView files.

Aliasing

Any molecular resonance that is observable along a particular dimension (according to the gyromagnetic ratio, γ) but is outside the spectral width is aliased. The degree of aliasing (α) for a given point with chemical shift delta is given by:

$$α = \vert \frac{2 ω ( δ - {δ}_{ref} )}{N} \vert \qquad Eq . 3.2$$

where δ_{ref} is the chemical shift at the centre point of the dimension and N is the Nyquist frequency or spectral width (in Hz). Aliased resonances have α values greater than 1.0. For each Gaussian resonance, those digitized points which have odd values of α are negated:

$$g ( {x}_{i} ) = \{ \begin{matrix}\frac{ρ}{σ \sqrt{2 π}} {e}^{- {( {x}_{i} - δ )}^{2} / 2 {δ}^{2 }} & for & α ( {x}_{i} ) = 0 , 2 , 4 … \\ - \frac{ρ}{σ \sqrt{2 π}} {e}^{- {( {x}_{i} - δ )}^{2} / 2 {δ}^{2 }} & for & α ( {x}_{i} ) = 1 , 3 , 5 …\end{matrix} \} \qquad Eq . 3.3$$

to simulate the folding of peaks seen in experimental NOESY spectra.

Spectral Crosspeaks

In NMRSwarm, spectral crosspeaks arise from any possible off-diagonal interaction between two or more resonances, regardless of whether any significant intensity is observed in the experimental data. In an n-dimensional NOESY spectrum, the Gaussian crosspeak function (Γₓ) is calculated as the product of the individual Gaussian resonances from each dimension:

$${Γ}_{x} = {\prod }_{d = 1}^{n} f ( x ) \qquad Eq . 3.4$$

where f(x) describes the Gaussian-shaped resonance along dimension d.

The set of pixels, Pₓ, in an n-dimensional NOESY crosspeak is given by:

$$\sqrt{{\sum }_{d = 1}^{n} {( \frac{{δ}_{d} ( p ) - {δ}_{d}}{{σ}_{d}} )}^{2}} \leq κ , p ∈ {P}_{S} \qquad Eq . 3.5$$

where δ_{d}(p) is the chemical shift of pixel p in dimension d (taking any resonance aliasing into account), κ is the degree of intensity coverage in any dimension, and P_{S} is the set of all pixels in the NOESY spectrum. The Gaussian intensity of each pixel, Γp, in the crosspeak is calculated from the product of the Gaussian intensities of the resonance point in each dimension:

$${Γ}_{p} = {\prod }_{d = 1}^{n} f ( {δ}_{d} ( p ) ) \qquad Eq . 3.6$$

Crosspeak Ambiguity

The degree of ambiguity of a NOESY crosspeak x is one determinant of the force constant applied to the NOE restraint during restrained molecular dynamics. The degree of ambiguity, μₓ, is calculated as the relative contribution of the crosspeak to the total spectral intensity underlying that peak, assuming that all NOEs were equally intense:

$${μ}_{x} = \frac{{\sum }_{p ∈ {P}_{x}} \vert f ( δ ( p ) ) \vert}{{\sum }_{y ∈ {X}_{S}} {\sum }_{p ∈ ( {P}_{x} ⋒ {P}_{y} )} \vert f ( δ ( p ) ) \vert} \qquad Eq . 3.7$$

where X_{S} is the set of all crosspeaks in the NOESY spectrum. Thus a completely unambiguous crosspeak has an μₓ of 1.0.

ISPA Back-Calculation

The back-calculated NOESY spectrum (Ω_{β}) is a weighted composite of all the Gaussian crosspeaks. It is calculated using the isolated spin pair approximation (ISPA) through the summation of all observable interproton NOEs:

$${Ω}_{β} = {\sum }_{n ∈ N} {\sum }_{x ∈ {X}_{n}} {Γ}_{x} {\sum }_{i < j} \frac{1}{{r}_{ij}^{6}} \qquad Eq . 3.8$$

where rᵢⱼ is the interatomic distance between protons i and j, or the current equilibrium distance in the interproton NOE restraint, N is the set of NOEs observable in the spectrum, and Xₙ is the set of crosspeaks arising from NOE n.

NOESY Calibration

Each back-calculated NOESY spectrum is calibrated by linear least-squares fit to the experimental spectrum yielding the scaling factor m_{S}:

$${m}_{S} = \frac{\overline{{ɛ}_{p} {β}_{p}}}{\overline{{ɛ}_{p}^{2}}} , p ∈ {P}_{S} \qquad Eq . 3.9$$

where εₚ and βₚ are the experimental and back-calculated intensities of pixel p, respectively, and P_{S} is the set of unmasked pixels in the NOESY spectrum. The correlation coefficient for this straight line fit is given by:

$${ρ}_{S} = \frac{\overline{{ɛ}_{p} {β}_{p}} - \overline{{ɛ}_{p}} \cdot \overline{{β}_{p}}}{σ ( {ɛ}_{p} ) σ ( {β}_{p} )} , p ∈ {P}_{S} \qquad Eq . 3.10$$

where σ(εₚ) and σ(βₚ) are the standard deviations in the experimental and back-calculated intensities, respectively. During the course of the structure calculation, the m_{S} scaling factors that give the best correlations to the experimental data (i.e. highest ρ_{S}) are recorded for each spectrum for subsequent χ² crosspeak analysis.

NOESY Masks

The diagonal of the NOESY spectrum and any regions that contain significant experimental artefacts can be disqualified from involvement in back-calculation and NOE calibration through the use of a binary mask. Any pixel whose mask bit is set is ignored in the NOESY back-calculation and calibration. Any crosspeak that contains a masked pixel is disqualified from involvement in NOE restraints. Any crosspeak that is entirely comprised of masked pixels is removed.

Intensity Output

Back-calculated NOESY spectra are output in either a FELIX or NMRView format.

The Potential Energy Function

In NMRSwarm, the potential energy function, Eₚₒₜₑₙₜᵢₐₗ, describes the energy of the molecule(s) as a function of the atomic coordinates. It contains conformational (geometric), non-bonded and experimental interaction energy terms:

Eₚₒₜₑₙₜᵢₐₗ=E_{bond}+E_{angle}+E_{dihedral}+Eᵢₘₚᵣₒₚₑᵣ+E_{vdw}+E_{NOE} Eq. 4.1

The Geometric Energy Functions

A harmonic approximation is used to account for deformations in bond length, bond angles, chirality and planarity in the molecular structure. The covalent bond energy, E_{bond}, is given by:

$${E}_{bond} = {w}_{bond} {\sum }_{bonds} {{k}_{bond} ( r - {r}_{0} )}^{2} \qquad Eq . 4.2$$

where r is the interatomic distance, k_{bond} is the bond force constant and r₀ is the equilibrium bond length. The three-atom bond angle energy, E_{angle}, is described by:

$${E}_{angle} = {w}_{angle} {\sum }_{angles}^{ } {{k}_{angle} ( θ - {θ}_{0} )}^{2} \qquad Eq . 4.3$$

where θ is the three-atom bond angle, k_{angle} is the force constant and θ₀ is the equilibrium value for the angle. The planarity and chirality of four-atom groups (i,j,k,l) are maintained through “improper” torsion angles between the planes ijk and jkl:

$${E}_{improper} = {w}_{improper} {\sum }_{impropers} {{k}_{improper} ( θ - {θ}_{0} )}^{2} \qquad Eq . 4.4$$

where φ the actual torsion angle, kᵢₘₚᵣₒₚₑᵣ is the force constant and σ₀ is the equilibrium torsion angle.

The dihedral angle term, E_{dihedral}, describes multi-minimum torsion potentials as a cosine expansion:

$${E}_{dihedral} = {w}_{dihedral} {\sum }_{dihedrals} {{k}_{dihedral} ( 1 + cos ( n φ + δ ) )}^{2} \qquad Eq . 4.5$$

where φ the actual torsion angle, k_{dihedral} is the force constant and δ is the phase shift on the torsion angle.

The force constants, equilibrium values and phase shifts for the above energy terms are as listed in the CNS parameter file parallhdg5.1.pro. The weights on the geometric terms (w_{bond}, w_{angle}, . . . ) are usually held equal and constant at 1.0 throughout the structure calculation.

The Non-Bonded (Van der Waals) Energy Function

The non-bonded energy term, E_{vdw}, is a soft, purely repulsive function without attractive or electrostatic components. Interactions between bonded atoms, and those between atoms that are bonded to a common third atom are excluded from E_{vdw}. Interactions between atoms that are connected through three covalent bonds (so called 1-4 non-bonded interactions) are computed using modified equilibrium distances. Non-bonded energy terms are truncated at an interatomic distance rᵢ for atom pairs that are too close to each other to minimize numerical instabilities in the case of strained initial coordinates or close contacts during high simulation temperatures. Thus the non-bonded energy is given by:

$${E}_{vdw} = {w}_{vdw} ( \begin{matrix}{\sum }_{vdws} {max ( 0 , {r}_{min} - max ( r , {r}_{i} ) )}^{4} + \\ {\sum }_{1 , 4 - vdws} {max ( 0 , {r}_{min 1 , 4} - max ( r , {r}_{i} ) )}^{4}\end{matrix} ) \qquad Eq . 4.6$$

where r is the interatomic distance,

$${r}_{min} = σ \sqrt[6]{2} and {r}_{min 1 , 4} = {σ}_{1 , 4} \sqrt[6]{2} .$$

For interactions between identical atom types, the values of σ and σ_{1,4} are as defined in the PROLSQ option in the CNS parameter file parallhdg5.1.pro. Between different atom types, the following combination rules are used:

$${σ}_{ij} = \frac{{σ}_{ii} + {σ}_{jj}}{2} and {σ}_{1 , 4 ij} = \frac{{σ}_{1 , 4 ii} + {σ}_{1 , 4 jj}}{2} \qquad Eq . 4.7$$

The weighting on the non-bonded energy term, w_{vdw}, is regulated during the structure calculation to allow or inhibit close atom contacts.

The NOE Energy Function

The NOE energy function, E_{NOE}, takes the form of a pseudo-harmonic potential with a high-end asymptote:

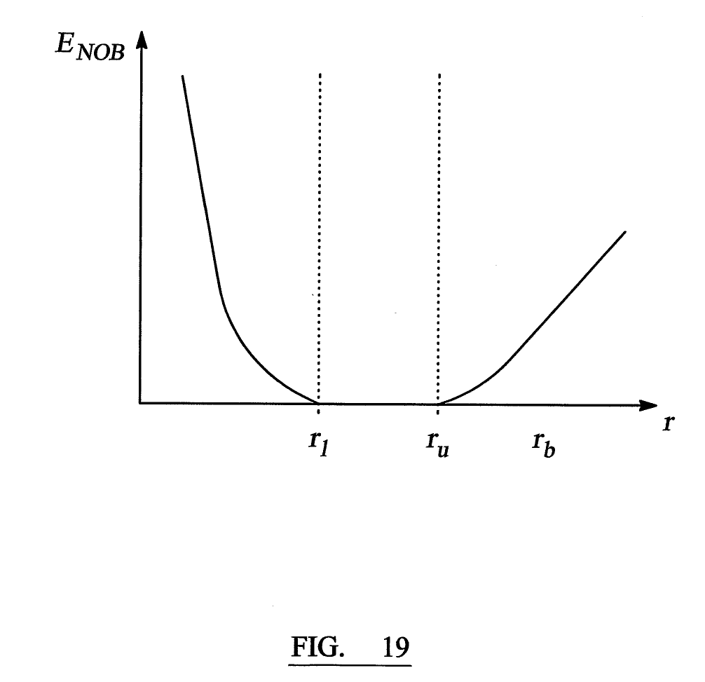

E_{NOE}=k_{NOE}(max(0,r₁−r)²+max(0, r−rᵤ)×max(0, min(r_{b}, r)−r)) Eq. 4.8

where k_{NOE} is the individual NOE force constant, rₗ is the lower bound on the flat well of the potential, rᵤ is the upper bound, r_{b} is a barrier above which a linear asymptote is applied. The pseudo-harmonic E_{NOE} potential with a high-end asymptote is shown in FIG. 19. This asymptote reduces numerical instabilities for those interproton distances that deviate dramatically from the upper bound.

The values of k_{NOE}, rₗ and rᵤ are specific to each NOE and are determined on-the-fly during the molecular structure calculation. The value of r_{b} (the “NOE barrier”) is constant for all NOE restraints (typically 5.0 Å). When both resonances are single protons, r is the interproton distance, otherwise an r⁻⁶ summed distance is calculated for all i-j proton pairings:

$$r = {( {\sum }_{i , j} \frac{1}{{r}_{ij}^{6}} )}^{- \frac{1}{6}} \qquad Eq . 4.9$$

Restrained Molecular Dynamics/Simulated Annealing

Cartesian Molecular Dynamics

Molecular dynamics consists of solving Newton's equations of motion:

$${m}_{i} \frac{{d}^{2} {r}_{i}}{d {t}^{2}} ( t ) = - \frac{d ( {E}_{potential} )}{d {r}_{i}} \qquad Eq . 5.1$$

where the index i runs through all atoms in the molecule. NMRSwarm uses a modified Cartesian molecular dynamics algorithm which incorporates a frictional term that controls the temperature of the system, which is described in Berendsen et al., 1984 as:

$${m}_{i} \frac{{d}^{2} {r}_{i}}{d {t}^{2}} ( t ) = - \frac{d ( {E}_{potential} )}{d {r}_{i}} - {m}_{i} {b}_{i} \frac{d {r}_{i}}{d t} ( t ) \qquad Eq . 5.2$$

where the friction coefficient bᵢ (units of ps⁻¹) is computed from the equation:

$${b}_{i} = {b}_{i}^{I} ( \frac{{T}_{0}}{T} - 1 ) \qquad Eq . 5.3$$

where bᵢ^{I} is an atom-specific friction constant, T₀ is the target temperature and T is the current temperature which is given by:

$$T = \frac{1}{{n}_{deg} {k}_{B}} {\sum }_{i} {,}_{i} {\vert \frac{d {r}_{i}}{d t} \vert}^{2} \qquad Eq . 5.4$$

MD Integrator: Verlet Leapfrog

Solving Newton's equation of motion requires a numerical procedure for integrating the differential equation. A standard method for solving ordinary differential equations such as this is the finite-difference approach. In this approach, the molecular coordinates and velocities at time t+Δt are obtained (to a sufficient degree of accuracy) from the molecular coordinates and velocities at an earlier time t. In NMRSwarm, Cartesian molecular dynamics is performed using the Verlet leap-frog integrator (Verlet, 1967), so called for its half-step scheme: the velocities are evaluated at the mid-point of the position evaluation and vice versa:

$$\begin{matrix}{r}_{n + 1} = {r}_{n} + \frac{\partial {r}_{n + 1 / 2}}{\partial t} Δ t & Eq . 5.5 \\ \frac{\partial {r}_{n + 1 / 2}}{\partial t} = \frac{\partial {r}_{n - 1 / 2}}{\partial t} + \frac{\partial {( {E}_{potential} )}_{n}}{\partial t} \times \frac{Δ t}{m} & Eq . 5.6\end{matrix}$$

The choice of the time interval Δt is a trade-off between economy and accuracy.

Simulated Annealing

Restrained molecular dynamics simulations have a much larger radius of convergence than techniques involving distance geometry and conjugate-gradient minimization because, due to the kinetic energy of the system, they are able to overcome the barriers surrounding local potential energy minima. This ability may be enhanced by elevating the temperature (thus increasing the kinetic energy) and by weakening the van der Waals repulsion (thus diminishing the energy barriers) in a procedure known as “simulated annealing”. In this procedure the system is driven towards the global potential energy minimum by thermal coupling to a “heat bath”: increased kinetic energy, resulting from random conformational changes which reduce the potential energy, is dissipated to the bath making the reverse conformational transition very unlikely. Following the high temperature dynamics, the system is cooled and the van der Waals repulsion restored, effectively trapping the system in the global potential energy minimum.

Update of NOE restraints

NOE Contributions

Each NOE can give rise to one or more crosspeaks in multiple NOESY spectra. Therefore, NOE restraints are constructed from multiple contributions, each arising from a separate crosspeak. Each crosspeak contribution has its own ambiguity factor (μ_{X}) which depends on the degree of spectral overlap, its own equilibrium distance (r₀) that best fits the experimental data, and its own force constant (k_{NOE}) that reflects the degree of fit to the experimental data.

Since the least ambiguous crosspeaks are the most reliable source of information, the equilibrium distance for NOE restraint n is calibrated by the weighted average:

$${r}_{0} = {\sum }_{x ∈ {X}_{N}} \frac{{μ}_{x} {r}_{0 x}}{{\sum }_{y ∈ {X}_{N}} {μ}_{y}} \qquad Eq . 6.1$$

where X_{N} is the set of crosspeaks that arise from NOE n. The upper and lower bounds on the equilibrium distance, rᵤ and rₗ (see Section 3._ . . . ), are set at a fixed percentage above and below r₀, respectively.

Similarly, the force constant for the NOE restraint n is given by the weighted mean:

$${k}_{NOE} = {\sum }_{x ∈ {X}_{N}} \frac{{μ}_{x} {k}_{NOEx}}{{\sum }_{y ∈ {X}_{N}} {μ}_{y}} \qquad Eq . 6.2$$

The force constant for NOE contribution x reflects the degree of ambiguity of the crosspeak, the level of agreement with the experimental data, and the distance of r₀ beyond the NOE barrier r_{b}, and is given by:

$${k}_{NOEx} = \frac{{μ}_{x}^{2} {ρ}_{x}^{4}}{1 + max ( 0 , {r}_{0} - {r}_{b} ) / a} \qquad Eq . 6.3$$

where α is a constant and ρₓ, the correlation coefficient over the crosspeak is given by:

$${ρ}_{P} = \frac{\overline{{ɛ}_{p} {β}_{p}} - \overline{{ɛ}_{p}} \cdot \overline{{β}_{p}}}{σ ( {ɛ}_{p} ) σ ( {β}_{p} )} , p ∈ {P}_{x} \qquad Eq . 6.4$$

where σ(εₚ) and σ(βₚ) are the standard deviations in the experimental and back-calculated intensities, respectively, over the set of crosspeak pixels Pₓ.

NOE Updates

Following back-calculation of a NOESY spectrum from the atomic coordinates, the degree of fit of each crosspeak, x, to the experimental data is evaluated through a χ² squared test:

$${χ}_{x}^{2} = {\sum }_{p ∈ {P}_{x}} {( {ɛ}_{p} - {m}_{S} {β}_{p} )}^{2} , x ∈ X \qquad Eq . 6.5$$

where εₚ and βₚ are the experimental and back-calculated intensities of pixel p, respectively, and m_{S} is the calibration coefficient for the entire unmasked NOESY spectrum.

Any crosspeak which shows an improved fit (i.e. lower χ²) to the experimental data has its associated equilibrium distance (r₀) updated to the current (r⁻⁶ summed) interproton distance. The new χ² value (which is set to infinity initially) is memorised as a record of the quality of the fit.

NOE Memory Degradation

Incorrect distance calibrations of NOE contributions that happen to fit well with the experimental data (i.e. have a low χ²) must be “forgotten” to prevent misfolding of the molecule and the subsequent erroneous calibration of other interproton distances. This is achieved through degradation of the memorised degree of fit to the experimental data:

$$\frac{d ( {χ}^{2} )}{d t} = τ ( {χ}^{2} ) , τ \geq 0 \qquad Eq . 6.6$$

where τ is the NOE memory decay constant (units of ps⁻¹). Therefore, NOE distance calibrations are transient during the course of the structure calculation process and are continuously updated based on conformational experience.

NOE Restraint Combination

In order to further reduce the influence of spurious interproton distance calibrations that may arise during the swarm intelligence structure calculations, those NOE restraints with an equilibrium distance (r₀) less than the barrier (r_{b}) are combined. In brief, the NOEs are sorted with respect to r₀ and neighbouring pairs in the list are pooled into combined restraints. Thus, n−1 combined NOE restraints are generated from n individual NOEs. Each combined NOE restraint is applied in the molecular dynamics as an ambiguous restraint with an r⁻⁶ summed distance.

Floating Chirality

Distinct but non-stereospecifically assigned prochiral resonances (e.g. the methyl resonances of isopropyl groups) are arbitrarily assigned to either the pro-R or pro-S moiety in the assignment lists. At 1 ps intervals during the structure calculation, the stereo assignments of a constant proportion (typically 10%) of randomly chosen prochiral groups were swapped for each agent. Only those exchanges that result in an improved fit to the experimental data (as judged by the sum of χ² differences for all related NOESY crosspeaks) are accepted. The best prochiral assignments are applied to the NOE restraints during the molecular dynamics.

Assessment of Final Structure Quality

The quality of the experimental restraints is determined from the correlation coefficient between a back-calculated restraints NOESY spectrum (a spectrum that would be produced if all interproton distances matched those of the restraints) and the experimental data. The level of agreement between the experimental restraints and the molecular structures is determined by the root mean square deviation (rmsd) from the equilibrium interproton distances. The stereochemical quality of the final structures was determined by ramachandran analysis using the program PROCHECK-NMR.

However, other programs may be used when determining the stereochemical quality of final structures.

Materials

Chemical Reagents

Deuterium oxide was supplied by CK Gas Products Ltd. (Wokingham, UK). Miili-Q water was supplied by Millipore (Watford, UK). All other chemical reagents were supplied by Sigma (Poole, UK).

The ¹F2 Module from Fibronectin

Uniformly ¹⁵N-labelled ¹F2 module, corresponding to residues A315-T374 of mature human fibronectin, was produced from the methylotrophic yeast Pichia pastoris as described previously (Pickford et al., 1997; Bright et al., 2000). Samples for NMR spectroscopy were dissolved to a concentration of 1.5 mM in either 5% D₂O/95% H₂O with 20 mM potassium phosphate pH 6.0, or 99.96% D₂O with 20 mM potassium phosphate pH 6.0 (pH meter uncorrected for deuterium). ¹H and ¹⁵N chemical shift assignments for the ¹F2 module at pH 6.0 and 25° C. have been published previously (Smith et al., 2000) along with a solution structure determined by manual assignment of NOEs (Pickford et al., 1997).

The FERM3 Module from Talin

Uniformly ¹⁵N-labelled FERM3 module, corresponding to residues 309-405 of mature mouse talin containing the point mutation C336S, was produced from Escherichia coli in M9 minimal media by Dr. Kate Wegener (Oxford University) as previously described (de Pereda J M et al., 2005). Samples for NMR spectroscopy were dissolved to a concentration of 1.5 mM in either 5% D₂O/95% H₂O, or 99.96% D₂O. The samples were buffered with 50 mM potassium phosphate to pH 6.1 (pH meter uncorrected for deuterium) and contained 100 mM NaCl. These conditions were used previously for ¹H and ¹⁵N chemical shift assignments of the module at 25° C. (de Pereda J M et al., 2005). No solution structure has been determined to date. However, a crystal structure of a chimeric complex between FERM3 and a peptide from PIPKI has been published recently (de Pereda et al., 2005).

NMR Methods

Spectrometers

All NMR spectra were recorded on home-built GE-Omega spectrometers fitted with triaxial gradient, triple-resonance probes and operating at 11.4 T (500 MHz for ¹H, 50 MHz for ¹⁵N), 14.1 T (600 MHz for ¹H, 60 MHz for ¹⁵N) or 17.6 T (750 MHz for ¹H, 76 MHz for ¹⁵N). Pulsed field gradients were employed for coherence selection and water suppression ¹⁵N decoupling during acquisition was carried out using an 833 Hz GARP1 decoupling field NMR spectra were recorded at 25° C. for the ¹F2 and FERM3 modules.

NOESY Data Acquisition

Three NOESY spectra were recorded on each sample, a two-dimensional (2D) NOESY in 5% D₂O/95% H₂O, a 2D NOESY in 99.6% D₂O, and a three-dimensional (3D) ¹⁵N-edited NOESY in 5% D₂O/95% H₂O. In each case a relaxation delay of 1 s was used and the NOE mixing time was 50 ms. Spectra on the ¹F2 module and the FERM3 module were recorded with the acquisition parameters listed in Tables 2 and 3 respectively.

TABLE 2
Acquisition parameters for NOESY experiments on the ¹F2 module (14.1T).

| | Experiment | | | | | | |
|---|---|---|---|---|---|---|---|
| | 2D NOESY in | | 2D NOESY in | | 3D ¹⁵N-edited NOESY in | | |
| | 5% D₂O/95% H₂O | | 99.96% D₂O | | 5% D₂O/95% H₂O | | |
| | | Indirect | | Indirect | | Indirect | Indirect |
| Dimension | Direct ¹H | ¹H (NOE) | Direct ¹H | ¹H (NOE) | Direct ¹H | 15N | ¹H (NOE) |
| Spectral Width | 6666.7 | 6666.7 | 6666.7 | 6666.7 | 6666.7 | 800 | 6666.7 |
| (Hz) | | | | | | | |
| Dwell time | 150 | 150 | 150 | 150 | 150 | 625 | 150 |
| (μs) | | | | | | | |
| Complex | 1024 | 512 | 1024 | 512 | 512 | 24 | 256 |
| points | | | | | | | |
| Acquisition | 153.6 | 76.8 | 153.6 | 76.8 | 76.8 | 15.0 | 38.4 |
| time (ms) | | | | | | | |

TABLE 3
Acquisition parameters for NOESY experiments on the FERM3 module.

| | Experiment | | | | | | |
|---|---|---|---|---|---|---|---|
| | 14.1T 2D NOESY in | | 14.1T 2D NOESY in | | 11.8T 3D ¹⁵N-edited NOESY in | | |
| | 10% D₂O/90% H₂O | | 99.96% D₂O | | 10% D₂O/90% H₂O | | |
| | | Indirect | | Indirect | | Indirect | Indirect |
| Dimension | Direct ¹H | ¹H (NOE) | Direct ¹H | ¹H (NOE) | Direct ¹H | ¹⁵N | ¹H (NOE) |
| Spectral Width | 12500 | 6666.7 | 12500 | 6666.7 | 12500 | 1493 | 6993 |
| (Hz) | | | | | | | |
| Dwell time | 80 | 150 | 80 | 150 | 80 | 335 | 143 |
| (μs) | | | | | | | |
| Complex | 1024 | 1024 | 1024 | 1024 | 1024 | 30 | 170 |
| points | | | | | | | |
| Acquisition | 81.9 | 153.6 | 81.9 | 153.6 | 81.9 | 10.1 | 24.3 |
| time (ms) | | | | | | | |

NOESY Data Processing

Processing of NOESY data was performed using the program NMRPipe (Delaglio et al., 1995). All ¹H dimensions were processed with Lorentzian to Gaussian transformations to improve the resonance lineshape and enhance resolution (although other lineshapes and window functions could be used equally well). The ¹H dimensions of the 2D spectra were zero-filled to 1024 complex points to improve the digital resolution and then Fourier transformed and phased. The ¹H dimensions of the 3D NOESY spectra were processed in the same way except that zero-filling was performed to 512 complex points only. The 3D NOESY ¹⁵N dimensions were doubled in acquisition time through the use of linear prediction followed by the application of a Lorentzian-Gaussian window function, Fourier transformation and phasing. Spectra were referenced to an external 2,2-dimethyl-2-silapentane-5-sulfonate (DSS) sample at 0 ppm (¹H), with indirect referencing in the ¹⁵N dimension using a ¹⁵N/¹H frequency ratio of 0.101329118 (Wishart et al., 1995).

NOESY Data Masks

All NOESY spectral points within 0.1 ppm of the ¹H-¹H diagonal are exempt from the back-calculation and correlation stages as these intensities cannot be determined using the isolated spin pair approximation (ISPA). In addition, those intraresidue NOE crosspeaks exhibiting strong coupling interactions (and hence non-gaussian peakshapes), and spectral artefacts arising from truncation of the time-domain signal are also masked out. Any NOE crosspeak that resides in such a masked out region is ignored during the NOE restraint calibration stage.

Swarm Intelligence Structure Calculations

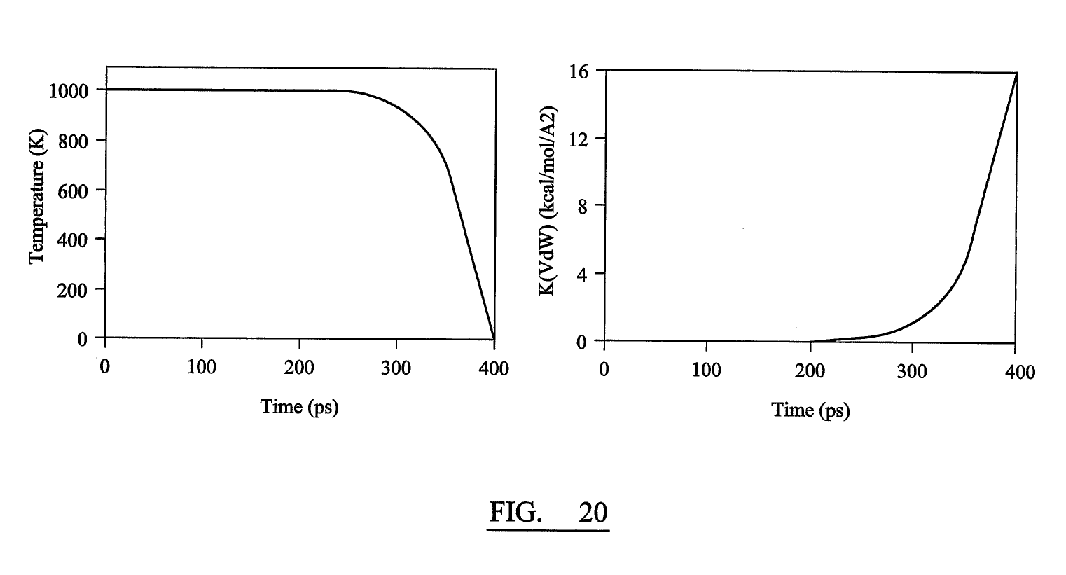

An identical simulated annealing protocol was used for both swarm intelligence structure calculations. The only parameters that were varied during the course of the annealing were the bath temperature and the force constant on the Van der Waals repulsion. Both of these were controlled with half-sigmoidal ramps with points of inflexion at 400 ps, the end of the simulation. In FIG. 20, the half-sigmoidal bath temperature and Van der Waals force constant ramps applied during the NMR swarm simulated annealing structure calculations.

Results

The ¹F2 Module from Fibronectin

The ¹F2 module solution structure was determined from a 20-agent swarm intelligence biomolecular structure calculation staring from randomised backbone conformations.

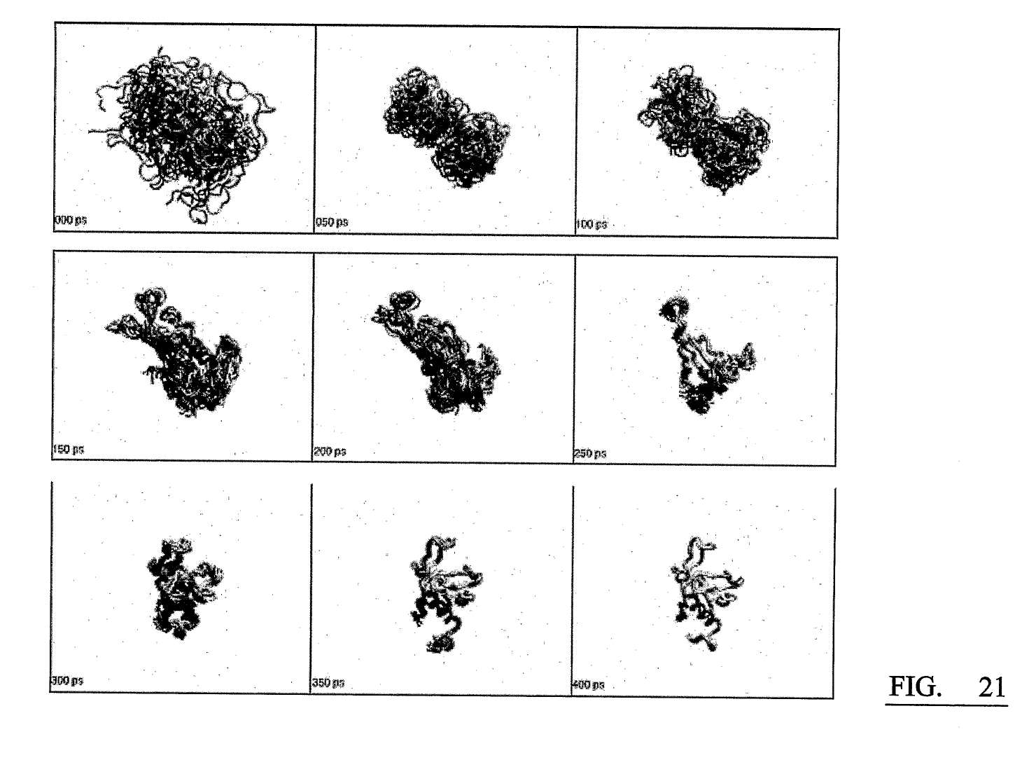

FIG. 21 shows the evolution of the fibronectin ¹F2 module swarm. The snapshots are from the 400 ps 20-agent swarm intelligence structure determination of the human fibronectin ¹F2 module with the β-strands coloured cyan and the α-helices red. At each time point, the molecules have been rotated with the same transformation that best overlays the backbone heavy atoms (N, C_{α} and C) at 400 ps.

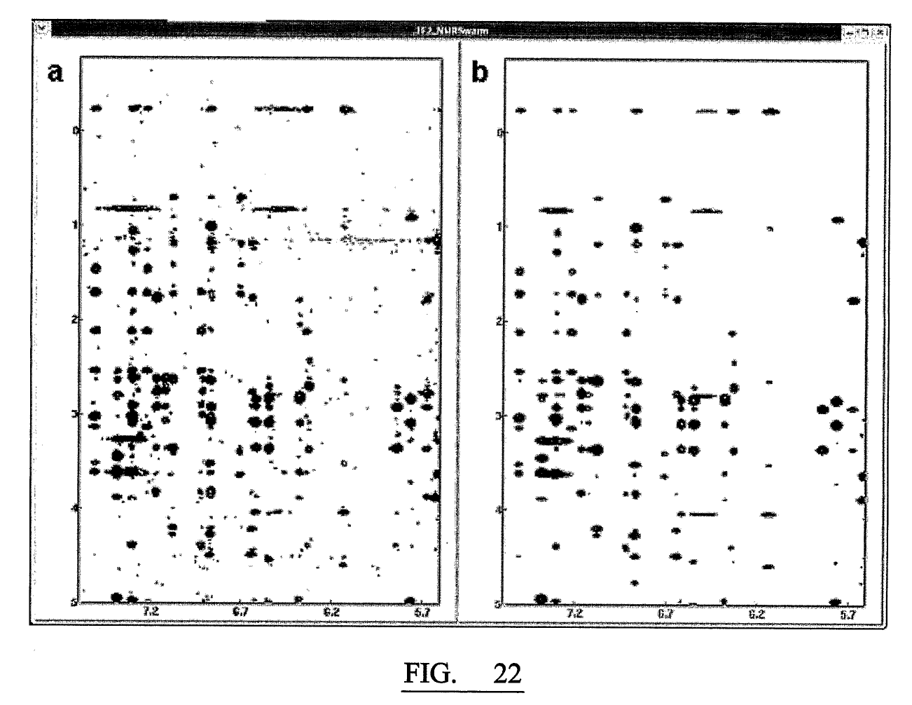

In FIG. 22, a comparison between experimental and back-calculated ¹F2 NOESY data is shown. In FIG. 22(a), an excerpt from the experimental 50 ms D₂O NOESY spectrum of ¹F2 showing many of the aromatic (x-axis) to aliphatic (y-axis) NOEs that characterize the module fold and in FIG. 22(b) a NOESY spectrum back-calculated using an isolated spin pair r₀⁻⁶ summation from the applied NOE restraints at time 400 ps.

At the end of the annealing, 13 of the agents were selected are representative of the ¹F2 module fold on the basis of their low potential energy. These agents are in close agreement with the previously-determined NMR structure of ¹F2 (Pickford et al., 1997) as shown by their backbone heavy atom (N, C□ and C) root mean square deviation (rmsd) of 0.91 Å.

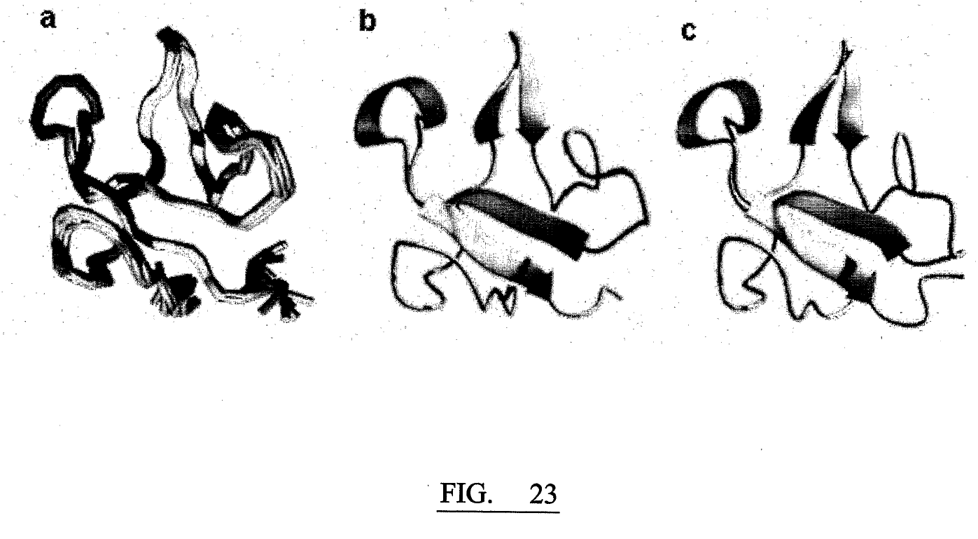

In FIG. 23, a comparison of the Swarm Intelligence NMR structure of ¹F2 with that derived previously from solution NMR data is made. In FIG. 23(a), an overlay of the selected ¹F2 molecular agents at the end of the swarm intelligence simulated annealing is shown. The average coordinates from the agents are shown as a ribbon representation in FIG. 23(b). FIG. 23(c) shows the solution NMR structure of the ¹F2 module as determined previously using the traditional iterative assignment scheme (Pickford et al., 1997).

The Critical Role of Cooperativity in Swarms Intelligence Structure Calculations

The success of the swarm intelligence strategy to biomolecular structure determination is due to the collective “intelligence” of the communicating agents. If this communication is absent during the parallel simulations then the strategy fails, since the isolated agents are incapable of searching sufficient conformational space to find the correct structure. Thus, traditional iterative assignment schemes, which employ serial, isolated structure calculations can never reach the level of convergence reported here for our swarm intelligence strategy.

The FERM3 Module from Talin

In order to further demonstrate the applicability of the swarm intelligence strategy, the FERM3 module from mouse talin was determined from a 20-agent swarm intelligence biomolecular structure calculation starting from randomised backbone conformations.

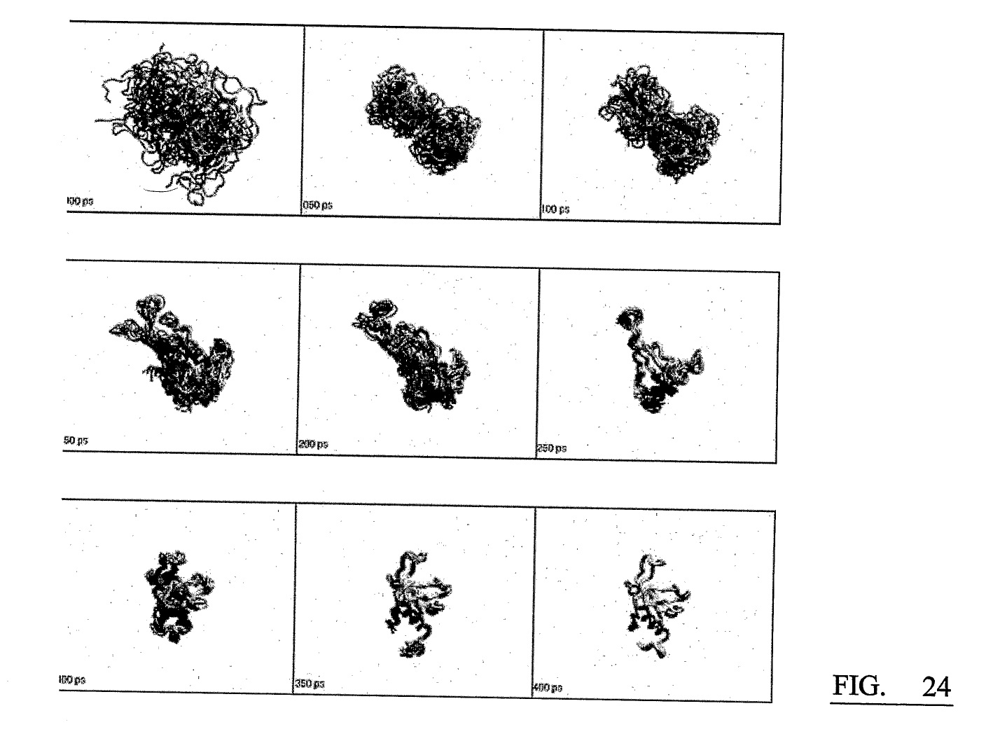

In FIG. 24, the Evolution of the FERM3 swarm can be appreciated. It shows snapshots from the 400 ps 20-agent swarm intelligence structure determination of the FERM3 module from mouse talin with the β-strands coloured cyan and the α-helices red. At each time point, the molecules have been rotated with the same transformation that best overlays the backbone heavy atoms (N, C_{α} and C) at 400 ps.

At the end of the annealing, 16 of the agents were selected as representative of the FERM3 module fold on the basis of their low potential energy. These agents are in close agreement with the coordinates of the FERM3 module in the previously-determined crystal structure of the FERM3-PIPKI□ (de Pereda et al., 2005) as shown by their backbone heavy atom (N, Cα and C) root mean square deviation (rmsd) of 1.04 Å.

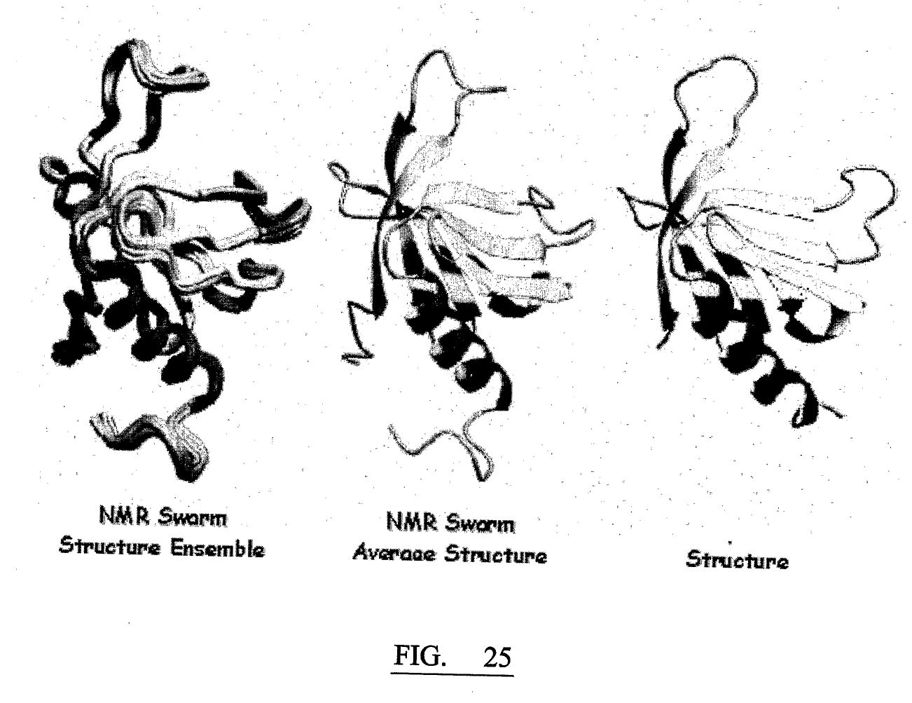

In FIG. 25, a comparison of the Swarm Intelligence NMR structure of FERM3 with that derived from X-ray crystallography is shown. FIG. 25(a) depicts the overlay of FERM3 molecular agents at the end of the swarm intelligence simulated annealing. FIG. 25(b) depicts the average coordinates from the selected agents are shown as a ribbon representation. FIG. 25(c) The crystal structure of the FERM3 module (de Pereda et al., 2005).

### REFERENCES

Berendsen, H. J. C., Postma, J. P. M., van Gunsteren, N. F., DiNola, A. and Haak, J. R. (1984). Molecular dynamics with coupling to an external bath. J. Chem Phys. 81, 3684-3690.
Bright J R, Pickford A R, Potts J R, Campbell I D. Methods Mol Biol. 2000;139:59-69. Preparation of isotopically labeled recombinant fragments of fibronectin for functional and structural study by heteronuclear nuclear magnetic resonance spectroscopy.
F. Delaglio, S. Grzesiek, G. W. Vuister, G. Zhu, J. Pfeifer and A. Bax: NMRPipe: A multidimensional spectral processing system based on UNIX pipes. J. Biomol. NMR. 6, 277-293 (1995).
De Pereda J M, Wegener K L, Santelli E, Bate N, Ginsberg M H, Critchley D R, Campbell I D, Liddington R C. J Biol Chem. Mar. 4, 2000; 280(9):8381-6. Structural basis for phosphatidylinositol phosphate kinase type Igamma binding to talin at focal adhesions.
Pickford A R, Potts J R, Bright J R, Phan I, Campbell I D. Structure. Mar. 15, 1997; 5(3):359-70. Solution structure of a type 2 module from fibronectin: implications for the structure and function of the gelatin-binding domain.
Smith S P, Hashimoto Y, Pickford A R, Campbell I D, Werner J M. Biochemistry. Jul. 25, 2000;39(29):8374-81. Interface characterization of the type II module pair from fibronectin.
Verlet, L. (1967). Computer experiments on classical fluids. I. Thermodynamical properties of Lennard-Jones molecules. Phys. Rev. 159, 98-105.
Wishart, D. S., Bigam, C. G., Yao, J., Abildgaard, F., Dyson, H. J., Oldfield, E., Markley, J. L., and Sykes, B. D. (1995) J. Biomol. NMR 6, 135-140.

1. A method of determining biomolecular structures from experimental data that includes ambiguous experimental observables comprising the steps of:
(i) creating a swarm of molecular structure generators having the ability to allow the communication between said generators via a global set of molecular restraints; and (ii) determining said molecular structure in a cooperative manner by using self-optimization of a multi-agent system.

2. A method according to claim 1, wherein the ambiguity is solved by identifying chemical shifts attributed to at least two proton resonances.

3. A method according to claim 1, wherein the biomolecular structure is determined by using Nuclear Magnetic Resonance.

4.-15. (canceled)

16. A method according to claim 2, wherein the biomolecular structure is determined by using Nuclear Magnetic Resonance.

17. A method according to claim 1, wherein the identification is based on the Nuclear Overhauser Effect.

18. A method according to claim 2, wherein the identification is based on the Nuclear Overhauser Effect.

19. A method according to claim 3, wherein the identification is based on the Nuclear Overhauser Effect.

20. A method according to claim 3, wherein an automated and single-step biomolecular structure is determined.

21. A method according to claim 17, wherein an automated and single-step biomolecular structure is determined.

22. An apparatus adapted to determining biomolecular structures from experimental data that includes ambiguous experimental observables comprising
(i) generating means for creating a swarm of molecular structure generators having the ability to allow the communication between said generators via a global set of molecular restraints; and
(ii) determining means for determining said molecular structure in a cooperative manner by using self-optimization of a multi-agent system.

23. The apparatus according to claim 22, wherein the ambiguity is solved by identifying chemical shifts attributed to at least two proton resonances.

24. The apparatus according to claim 22, wherein the biomolecular structure is determined by using Nuclear Magnetic Resonance.

25. The apparatus according to claim 22, wherein the identification is based on the Nuclear Overhauser Effect.

26. The apparatus according to claim 24, wherein an automated and single-step biomolecular structure is determined.

27. A computer program adapted to be run on a computer, for determining biomolecular structures from experimental data that includes ambiguous experimental observables, comprising the steps of claim 1.

28. The computer program according to claim 27, wherein the ambiguity is solved by identifying chemical shifts attributed to at least two proton resonances.

29. The computer program according to claim 27, wherein the biomolecular structure is determined by using Nuclear Magnetic Resonance.

30. The computer program according to claim 27, wherein the identification is based on the Nuclear Overhauser Effect.

31. The computer program according to claim 29, wherein an automated and single-step biomolecular structure is determined.
